(19) United States
(12) Patent Application Publication
(10) Pub. No.: US 2026/0287323 A1
(43) Pub. Date: Sep. 24, 2026

(54) HIGH-STRETCHABILITY AND LOW-HYSTERESIS STRAIN SENSING 3D MESOSTRUCTURES

(71) Applicant: University of Southern California, Los Angeles, CA (US)

(72) Inventors: Hangbo ZHAO, Los Angeles, CA (US); Xinghao HUANG, Los Angeles, CA (US)

(21) Appl. No.: 19/475,222

(22) PCT Filed: Apr. 19, 2024
(86) PCT No.: PCT/US2024/025551

§ 371 Date: Oct. 14, 2025

Related U.S. Application Data
(60) Provisional application No. 63/460,424, filed on Apr. 19, 2023.

(51) Int. Cl. G01B 7/16; G01B 1/00

(52) U.S. Cl. CPC G01B 7/22; G01B 1/00

(57) ABSTRACT

In some examples, a capacitive strain sensor is disclosed. The sensor can include a substrate and a pair of electrodes hingedly connected to the substrate at an inner edge and to each other along an upper edge. Each electrode can include a first panel connected to an upper surface of the substrate and a second panel hingedly connected to the inner edge of the first panel opposite the upper edge. Stretching the substrate can cause the pair of electrodes to hingedly move between a first state and a second state.

### CROSS REFERENCE TO RELATED APPLICATIONS

This application claims priority to U.S. Provisional Appl. No. 63/460,424, filed on Apr. 19, 2023, which is herein incorporated by reference in its entirety.

### TECHNICAL FIELD

Disclosed herein are systems, devices, and/or methods relating to strain sensors.

### BACKGROUND

Accurately measuring large deformations is an important requirement in a broad range of engineering applications, such as body motion tracking for healthcare, proprioception and control of soft robotics, and human-machine interfaces. Desirable sensor performances include large strain range, low hysteresis, high sensitivity and linearity, high stability and robustness, small size and weight, and convenient data acquisition and processing. Among the various strain conventional sensing mechanisms, resistive and capacitive sensing are studied extensively due to the convenience of sensor fabrication and signal readout. A commonly used strategy in these stretchable resistive and capacitive strain sensors is to directly use intrinsically conductive polymers or combine stretchable matrices with active conductive components.

Examples include conducting polymers, ionic liquids, liquid metals, and nanocomposites consisting of conductive particles dispersed in polymer matrices. Despite their large mechanical stretchability, many sensors exhibit undesirable characteristics for accurate strain sensing, such as electromechanical hysteresis, slow recovery, and lack of long-term stability. For example, conductive polymer nanocomposites often suffer from relatively large hysteresis in resistive strain sensing due to irreversible changes in the morphology of the conductive fillers during deformation; liquid metal-based sensors have challenges in sensor miniaturization, long-term stability due to oxidation, and robust encapsulation.

This disclosure resolves these and other issues of the art.

### SUMMARY

The subject of this disclosure includes a capacitive strain sensor. The sensor can include a substrate and a pair of electrodes hingedly connected to the substrate at an inner edge and to each other along an upper edge. Each electrode can include a first panel connected to an upper surface of the substrate and a second panel hingedly connected to the inner edge of the first panel opposite the upper edge. Stretching the substrate can cause the pair of electrodes to hingedly move between a first state and a second state.

In some examples, in the first state, the substrate being stretchable includes a first length defined by the inner edge of each electrode positioned near or adjacent the other so that the upper edge is positioned away from and/or above the substrate.

In some examples, in the first state, the second panels of each electrode collectively form a triangular-shaped structure having an apex at the upper edge.

In some examples, in the second state, the substrate includes a second length greater than the first length, the second length defined by the inner edge of each electrode positioned away from the other so that the upper edge is positioned in contact and/or adjacent the substrate and the panels of the electrodes are oriented parallel with each other

In some examples, the electrodes are mesoscale

In some examples, the substrate is elastomeric and/or stretchable

In some examples, each of the first and second panels include one or more conductive layers.

In some examples, the second panel is hingedly connected to the inner edge of the first panel opposite the upper edge with a crease-like structure including a polymer material deposited at or along the inner edge.

In some examples, one or more regions of the polymer material remain exposed between adjacent locations including the polymer material.

In some examples, the polymer material facilitates rotational movement of the pair of electrodes during stretching of the substrate.

In some examples, the first and second panels of each electrode includes a multi-layer construction including a metal layer sandwiched between a first polymer layer and a second polymer layer.

In some examples, the multi-layer construction further including a cover layer disposed over the first polymer layer or the second polymer layer.

In some examples, the cover layer includes silicone.

In some examples, the first and/or second polymer layers include parylene.

In some examples, the metal layer includes a transition metal such as chromium and/or gold.

In some examples, the polymer material is selected from the group of polymer materials having an increased level of stiffness when compared to the multi-layer construction. In some examples, the polymer material is a photodefinable epoxy.

In some examples, each electrode includes an electrically conductive trace extending configured to electrically connect with an external electrical device.

In some examples, the electrically conductive traces include a serpentine shape configured to stretch during stretching of the substrate.

In some examples, one or more electromagnetic shielding layers positioned on an outer surface of the substrate and/or each of the electrodes.

In some examples, the strain sensor includes up to approximately 200% stretchability.

In some examples, the strain sensor includes a hysteresis of less than approximately 2%.

In some examples, the strain sensor includes a response time of less than approximately 22 ms.

In some examples, the strain sensor includes a sensing area of approximately 5 mm².

In some examples, a method is disclosed. The method can include increasing or decreasing an electric field between electrodes of a capacitive strain sensor by moving electrodes of a strain sensor, the sensor including a substrate configured to stretch and hingedly connected to each of the electrodes at an inner edge, wherein each electrode is hingedly connected to each other along an upper edge and includes a first panel connected to an upper surface of the substrate and a second panel hingedly connected to the inner edge of the first panel opposite the upper edge; and measuring deformation based at least on detected capacitance between the electrodes as the substrate stretches and the electrodes move between one of a plurality of states.

In some examples, the method can include electrically connecting the electrodes to an external electrical device of a wearable device, a prosthetic, a soft robotics, a human-machine interface, an implantable device, a garment, and/or the like.

In some examples, a capacitive strain sensor is disclosed. The sensor can include a first electrode connected to a second electrode. The first and second electrodes can include a multilayer structure including an electrically conductive layer having inner and outer electrically insulating layers. An outer polymeric material can be disposed over the multilayer structure and forming a plurality of panels on the multilayer structure with exposed regions of the multilayer structure interposed therebetween. The panels can be arranged in series so that the first electrode is rotatably connected to the second electrode. A stretchable substrate can be attached to the first and second electrodes, at least one panel of each electrode being connected to the substrate. Stretching the substrate can cause the first and second electrodes to rotatably move between a first state and a second state, the second state being defined by at least one panel of each electrode being positioned upwardly away from the substrate and having an uppermost apex of the capacitive strain sensor.

In some examples, the panels of the first and second electrodes include stiffness to facilitate creasing of the exposed regions between the first and second states.

In some examples, the multilayer structure includes a first polymer layer, a metal layer, and a second polymer layer.

In some examples, an electrically nonconductive material can be disposed over and encapsulating the first and second electrodes.

In some examples, electrically conductive traces can be connected to the multilayer structure, wherein each of the first and second electrodes includes an electrically conductive trace extending therefrom is configured to stretch along with the substrate.

In some examples, a method is disclosed for fabricating a capacitive strain sensor. The method can include forming a two-dimensional precursor multilayer construction, including an electrically conductive layer; forming panels onto the multilayer construction by depositing a polymeric material thereon, one or more exposed regions of the multilayer construction exist between adjacent panels, wherein a first plurality of the panels form a first electrode and a second plurality of panels form a second electrode; and positioning at least a first panel of each electrode flat onto a surface of an elastomeric substrate and causing at least a second panel of each electrode to extend outwardly away from the substrate forming a shape where the first and second electrodes meet at an apex of the shape in a first state.

In some examples, the first and second foldable electrodes each include traces that are electrically connected therewith.

In some examples, the traces are formed during the step of forming the two-dimensional precursor multilayer construction and are configured to be movable.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 depicts a three-dimensional capacitive strain sensory system according on an example embodiment of this disclosure.

FIG. 2A shows a top view of a three-dimensional potential field of the example system of FIG. 1.

FIG. 2B shows a side view of a three-dimensional potential field of the example system of FIG. 1.

FIG. 2C shows a side-schematic illustration of example electrodes of the system of FIG. 1 under stretching.

FIGS. 3A to 3C illustrate example steps in a fabrication process of the system of FIG. 1.

FIG. 3D shows a graph that compares the noise levels of two example sensory systems of this disclosure using air and glycerol as the dielectric material.

FIG. 4 shows views A to E that depict example schematic top views of aspects of an example 2D precursor.

FIG. 5A illustrates an example scanning electron microscopy (SEM) image of an example system 100 structure (scale bar: 200 μm).

FIG. 5B illustrates a close-up of section 5B of FIG. 5A (scale bar: 50 μm).

FIG. 6 illustrates an example sensor system according to one example construction.

FIG. 7A shows an example top-view of 2D precursor according to one example of this disclosure.

FIGS. 7B, 7E, and 7F show example finite element analysis (FEA) graphics showing strain distribution in the electrodes of example sensor configurations of this disclosure.

FIGS. 7C, 7D, 7G, and 7H show example sensor configurations of this disclosure.

FIG. 8A shows an example top-view of 2D precursor according to one example of this disclosure.

FIGS. 8B, 8E, and 8F show example FEA analysis graphics showing strain distribution in the electrodes of example sensor configurations of this disclosure.

FIGS. 8C, 8D, 8G, and 8H show example sensor configurations of this disclosure.

FIGS. 9A and 9B show example sideview optical images and the corresponding simulated profiles according to example electrodes of this disclosure.

FIG. 9C provides a table that compares the heights of electrode structures with different electrode lengths according to examples of this disclosure.

FIG. 10A shows example sideview samples on day 1, day 3, and day 7, respectively, after being formed according to one example assembly process of this disclosure.

FIG. 10B shows a graph comparing distances of each sample of FIG. 10A as between the bonding sites measured from each day.

FIG. 11A shows a graph comparing simulated initial capacitance versus electrode length and width of the sensor system of this disclosure.

FIG. 11B shows a graph comparing simulated capacitance change versus applied strain of the sensor system of this disclosure.

FIG. 12A shows a graphic summarizing FEA showing strain distribution in the electrodes along with experimental images of example traces of the analyzed example sensor system under stretching.

FIG. 12B show example images of another example sensor system of this disclosure with a relatively long strip (e.g., approximately 40 mm in length) subjected to uniaxial stretching with nominal strains.

FIG. 13A shows a graph that depicts simulated, analytical, and experimental results for the relative change in bonding site distance and the corresponding relative capacitance change of the sensors system of this disclosure with approximately 0.5 mm in length.

FIG. 13B shows a graph comparing the loading and unloading curves of a representative sensor system of this disclosure stretched up to 200% strain at a strain rate of 10% s⁻¹.

FIG. 13C shows optical images of the precursor of a sensor system of this disclosure that includes a multi-crease electrode design and the resulting electrodes formed with different prestrain.

FIG. 13D shows a graph comparing relative capacitance change of a multi-crease strain sensor (300% prestrain) during uniaxial loading and unloading at 50%, 100%, 150%, and 200% applied strain.

FIG. 14A shows example images of another example sensor system of this disclosure with approximately 1 mm in length subjected to uniaxial stretching with nominal strains.

FIG. 14B shows a graph that depicts simulated, analytical, and experimental results for the relative change in bonding site distance and the corresponding relative capacitance change of the sensors system of this disclosure.

FIG. 14C shows a graph demonstrating relative change in capacitance of the sensor system of FIG. 14A, with different prestrain, during loading and unloading at applied strains of 50%, 100%, 150%, and 200%.

FIG. 15 depicts a graph showing capacitance change of a representative sensor under 100% applied strain with 0%, 10%, and 20% pre-stretch for one example sensor system of this disclosure.

FIG. 16A depicts a top view of a two-dimensional layout of the sensor system of this example embodiment.

FIG. 16B shows optical images of the front and angled view of the electrodes of the sensor system formed by compressive buckling.

FIG. 16C shows a graph depicting relative capacitance change of the sensor system of FIG. 16A during uniaxial loading and unloading at 50%, 100%, and 150% applied strain.

FIG. 16D shows a graph depicting capacitance change during cyclic 50% uniaxial loading and unloading.

FIG. 17 includes views (A) to (E) that illustrate schematics of an example sensor system of this disclosure that includes precursor of a five-crease example embodiment.

FIG. 18 includes views (A) to (F) that illustrate aspects of an example sensor system of this disclosure with a trapezoid-shaped second panel.

FIG. 19 is a table that summarizes performance parameters of sensors with different electrode designs under approximately 100% strain.

FIG. 20A depicts real-time response of one example strain sensor of this disclosure subjected to a 100% step strain, showing the response time and recovery time.

FIG. 20B depicts a three-dimensional graphical comparison of previously reported strain sensors in the sensor strain range, degree of hysteresis (DH), and response time.

FIG. 20C is a graph that compares time-varying capacitance response of one example sensor system of this disclosure.

FIG. 20D is a graph that compares capacitance response and hysteresis of the example sensor system at different strain rates.

FIG. 20E is a graph that compares relative capacitance change of an example sensor system under increasing strain with 1% strain increments according to one example.

FIG. 20F is a graph that shows relative capacitance change of a representative sensor over a number of loading/unloading cycles, with close-up views at the beginning and end of the test according to one example.

FIG. 21A depicts an example test setup to apply step strain on an example strain sensor systems of this disclosure.

FIG. 21B is a graph that compares capacitance responses from for the example strain sensor system tested with the setup of FIG. 21A.

FIG. 22 is a table that compares performance metrics of previously reported strain sensor systems.

FIG. 23A is a graph that compares capacitance response of a representative sensor subjected to a series of step-up strain followed by step-down strain to the initial state.

FIG. 23B is a graph that compares capacitance response of a representative sensor subjected to a series of step-up strain followed by step-down strain to the initial state.

FIG. 23C is a graph that compares relative capacitance change of a representative sensor under stretching with fine stepping profile.

FIG. 23D is a graph that compares noise signal relative to time for an example sensor system.

FIG. 24 is a graph comparing capacitance response of an example sensor system of this disclosure stretched to different levels under different static, persistent normal pressures.

FIG. 25 includes views (A) to (G) that describe mechanical robustness of example strain sensor systems of this disclosure against collisions and abrasions.

FIG. 26 includes views (A) to (D) that describe performance aspects of example strain sensor systems of this disclosure with electromagnetic shielding.

FIG. 27 shows views (A) to (C) of a directional strain sensing test of an example strain sensor system of this disclosure.

FIG. 28A shows a side view (top row) and top-down view (bottom row) of an example strain sensor system tested under compressive strain of approximately 0%, −20%, and −45%.

FIG. 28B is a graph that compares relative capacitance change of the example strain sensor system under different compressive strain at a scale of 1 mm for the top row and 5 mm for the bottom row in FIG. 28A.

FIG. 29A is a graph that compares relative capacitance change of an example strain sensor system attached to a silicone slab (e.g., a soft continuum arm) at different angles (0°, 45°, and) 90° with respect to a uniaxial stretching of 70% strain and with inset images that show top-down images of the related electrodes at 70% strain.

FIG. 29B illustrates an example of sensors in rosette patterns attached to the two surfaces of a soft continuum arm.

FIG. 30 includes graphs of distributed sensor responses during bending, twisting, stretching, compressing, and hybrid deformation modes.

FIG. 31A illustrates experimental images and simulated electric potential field for an investigated example strain sensor system placed at 45 degree with respect to the strain direction at 0% strain.

FIG. 31B illustrates experimental images and simulated electric potential field for an investigated example strain sensor system placed at 45 degree with respect to the strain direction being stretched to 70% nominal strain.

FIG. 31C is a graph comparing capacitance change from experiment and simulation shown in FIG. 31A and FIG. 31B.

FIG. 32 shows views (A) to (D) comparing local strain in an example deformed soft continuum arm from FEA and experimental measurements using example strain sensor systems attached to the deformed soft continuum arm.

FIG. 33 illustrates a flowchart for a fabrication process, according to an embodiment.

FIG. 34 illustrates a flowchart for a method of measuring capacitance changes with the example strain senor systems, according to an embodiment.

### DETAILED DESCRIPTION

Disclosed herein are systems, devices, and methods relating to strain sensors, including but not limited to the design, fabrication, and methods associated with stretchable three-dimensional capacitive strain sensors. Systems of this disclosure can include one or more stretchable strain sensors constructed in a manner that addresses limitations of prior approaches, including conventional stretchable strain sensors, and deliver the desired properties of large stretchability, ultralow hysteresis, and long-term stability (e.g., high repeatability), and fast response time when compared to conventional stretchable strain sensors.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise.

In this disclosure, the term “comprising” is synonymous with “including,” “having,” “containing,” or “characterized by.” These terms are inclusive and open-ended and do not exclude additional, unrecited elements or method steps. By using any of these terms, it is meant that at least the named compound, element, particle, or method step is present in the composition or article or method, but does not exclude the presence of other compounds, materials, particles, method steps, even if the other such compounds, material, particles, method steps have the same function as what is named.

In this disclosure, the phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

In this disclosure, the phrase “consisting essentially of” limits the scope of a claim to the specified materials or steps, plus those that do not materially affect the basic and novel characteristic(s) of the claimed subject matter.

In this disclosure, where publications are referenced, the disclosures of these publications in their entireties are hereby incorporated by reference into this application.

In this disclosure, relative terms, such as “about,” “substantially,” or “approximately” are used to indicate a possible variation of ±10% in the stated value.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

The following examples illustrate the various embodiments of the present disclosure. Those skilled in the art will recognize many variations that are within the spirit of the present disclosure and scope of the claims.

Disclosed herein are three-dimensional (3D) strain sensor systems that make use of a deformable non-parallel-plate configuration. In an example, the strain sensors of this disclosure can have electrode structures that include one or more foldable electrodes. In some aspects, strain sensing systems of this disclosure are capable of mechanical stretching and achieving stretchable strain sensing without relying on stretchable conductive materials. Such systems can include wavy structures, fractal designs, twisted or helical structures, open-mesh structures, and foldable structures with engineered cuts. For example, parallel-plate capacitive strain sensors utilizing wrinkled ultrathin gold film electrodes exhibit high sensitivity and linearity with small hysteresis, but with limited stretchability (e.g., 140%). Similar wrinkled metal thin film electrodes on microstructured elastomeric surfaces provide increased stretchability (e.g., up to 250% strain) but suffer from uncontrollable crack propagation in the metal thin films at large strain. Auxetic structures with engineered cuts can provide stretchability for parallel-plate capacitive sensors but with limited stretchability (e.g., 50%). Stretchable strain sensors with large stretchability, low hysteresis, and long-term stability are highly desirable, especially for accurate measurement of large and complex deformations.

In some aspects, the one or more folded plates can be fabricated by a mechanically guided assembly process. The assembly process can geometrically transform two-dimensional (2D) electrode patterns into out-of-plane folded plates with controllable folding angles that are covalently bonded to a substrate (e.g., a stretchable substrate such as a silicone elastomeric substrate). The resulting system can convert large deformations of the substrate to changing angles between electrodes of the folded 3D plate to impart large stretchability (e.g., up to approximately 200%), ultralow hysteresis (e.g., below approximately 2%), high repeatability (e.g., over approximately 700 cycles), fast response time (e.g., <approximately 22 ms), and small sensor footprint (e.g., sensing area approximately 5 mm²).

In some aspects, 3D strain sensors and related electrodes of this disclosure allow for compressive strain sensing and directional strain responses, which are distinct from many existing stretchable strain sensors. The millimeter-scale sensing area on a thin substrate enables the attachment of the sensor on soft bodies using a simple stick-on method, which separates the sensor fabrication and implementation on target objects. These features are particularly attractive for distributed sensing of soft body deformation, as demonstrated in a soft continuum arm. This concept of foldable, 3D stretchable capacitive sensors can be used in wearable sensors, prosthetics, soft robotics, human-machine interfaces, implantable devices, and the like.

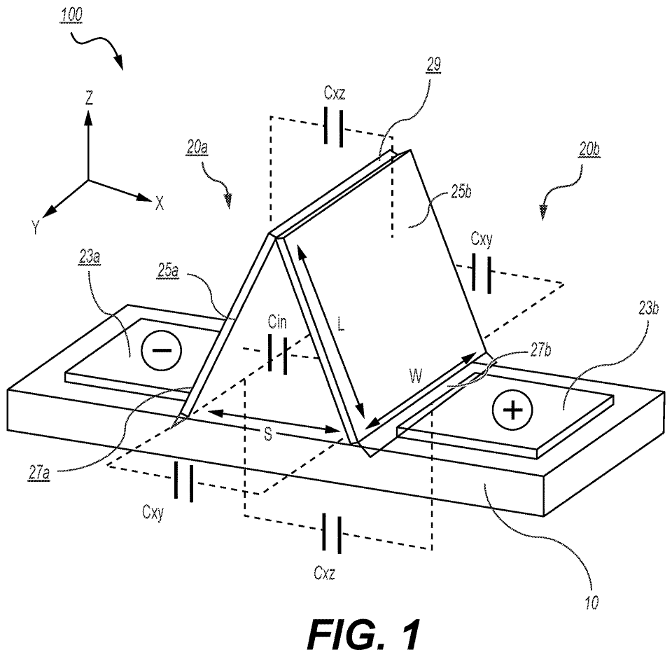

Turning to FIG. 1, an example three-dimensional capacitive strain sensor system 100 is shown. System 100 can include a pair of electrodes 20a, 20b. Electrodes 20a, 20b can be foldable 3D mesoscale electrodes. In some aspects, the pair of electrodes 20a, 20b can include a multi-panel thin film arranged in a foldable shape (e.g., a triangular shape, as in FIG. 1) on a substrate 10. Each electrode 20a, 20b can include a first panel 23a, 23b connected to substrate 10 and a second panel 25a, 25b free to rotate. Crease-like structures 27a, 27b can be arranged between respective panels of each electrode 20a, 20b to connect the panels. In some aspects, a crease-like structure 29 can be positioned between upper top edges of panels 25a, 25b. In some aspects, each of structures 27a, 27b, and 29 can operate in a hinge-like manner as between adjoining panels. In some aspects, stretching substrate 10 can cause electrodes 20a, 20b to bias or otherwise move between states (e.g., a first state defined by the electrodes 20a, 20b being substantially upright, a second state defined by the electrodes 20a, 20b being flat and/or oriented parallel with respect to the substrate 10, and any number of states between the first and second states, etc.) can generate a three-dimensional electric field with field lines within and outside the shaped panels (e.g., panels 25a, 25b), as well as those panels 23a, 23b crossing substrate 10 from the panels 23a, 23b of electrodes 20a, 20b, respectively.

In some aspects, system 100 can include a film formed at least partially with electrodes 20a, 20b (e.g., a multi-panel thin film such as between approximately 10 micron and 100 micron in thickness). The film can take any number of shapes, such as those described herein with respect to the foldable electrodes, including but not limited to a triangular shape on substrate 10.

This disclosure is more clearly understood with corresponding studies discussed more particularly below with respect to aspects, advantages, and fabrication of the herein disclosed strain sensor systems. It is understood that the examples and related data is presented herein for purposes of illustration and should not be construed as limiting the scope of the disclosed technology in any way or excluding any alternative or additional embodiments.

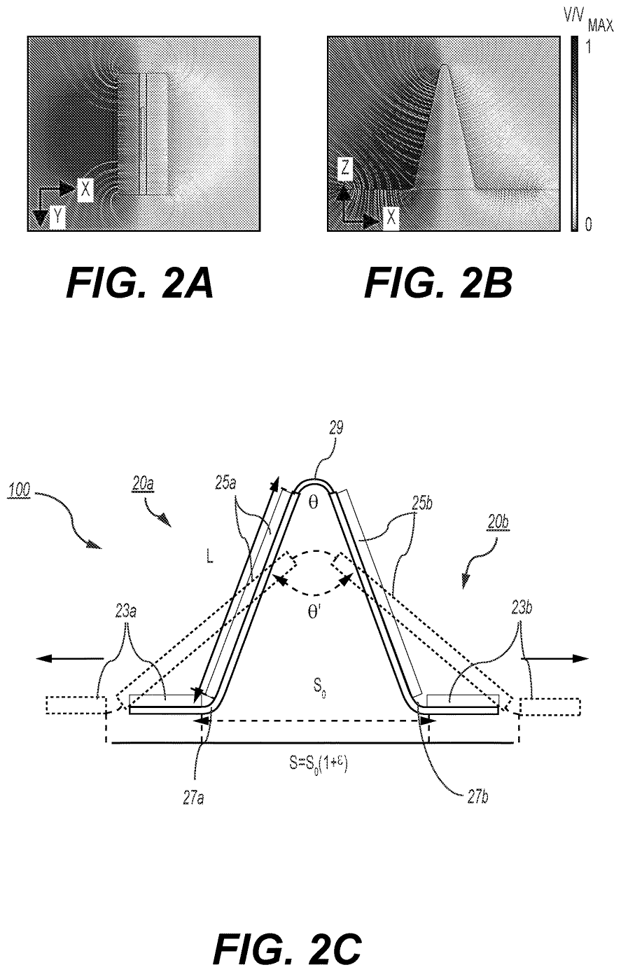

FIG. 2A shows a side view of the 3D potential field of system 100 from finite element analysis (FEA) with the electric field lines highlighted. FIG. 2B shows a top view of the 3D potential field of system 100 from FEA with the electric field lines similarly highlighted. In FIGS. 2A and 2B, the capacitance measured between the electrodes of system 100 can include an inner capacitance between the two angled panels 25a, 25b within the shape (e.g., triangular shape) of Cᵢₙ, capacitances between the electrodes 20a, 20b outside the shape in the xy plane C_{xy}, and in the xz plane C_{xz}. The total capacitance between the electrodes 20a, 20b, Cₜₒₜₐₗ, is approximately the sum of these components due to their parallel configuration:

$${C}_{total} \approx {C}_{i n} + {C}_{xy} + {C}_{xz}$$

In some aspects, Cᵢₙ, C_{xy}, and C_{xz} can be analytically approximated using a capacitance model of non-parallel plates via a conformal mapping approach. In some aspects, partial bonding of the electrodes 20a, 20b to substrate 10 and foldable structures 27a, 27b, 29 can allow electrodes 20a, 20b to be stretched or compressed along the x direction, which changes the distance between the panels 23a, 23b that are connected to substrate 10 and the folding angles θ of structures 27a, 27b, 29. In some aspects, the herein disclosed strain sensor systems are advantageously foldable and can include mesoscale electrodes with stretchable substrates (e.g., elastomeric) for capacitive strain sensing. In some aspects, the substrates and the reversible folding/unfolding of the electrodes can allow for a relatively large strain sensing range with. minimal hysteresis. In some aspects, the herein disclosed systems are advantageous for combining relatively large stretchability, small hysteresis, fast response speed, directional strain response, and small sensor footprint that can be used for accurately measuring local strain of large, complex, and multimodal deformations, as found in animals (e.g., octopus arms and elephant trunks), humans (e.g., lungs), and soft robots.

FIG. 2C schematically shows the stretching of electrodes 20a, 20b under strain ε and the increase of the top crease angle from θ to θ′ due to unfolding of panels 25a, 25b. Example positions of panels of electrodes 20a, 20b are shown with the phantom lines denoting the under strain configuration. Analytical approximations indicate decreases in Cᵢₙ, C_{xy}, and C_{xz} with increasing top crease angle from θ to θ′, causing a decrease in the total capacitance Cₜₒₜₐₗ. As a result, stretching or compressing substrate 10 can change the 3D electric field between electrodes 20a, 20b, leading to an increase or decrease in the total measured capacitance Cₜₒₜₐₗ.

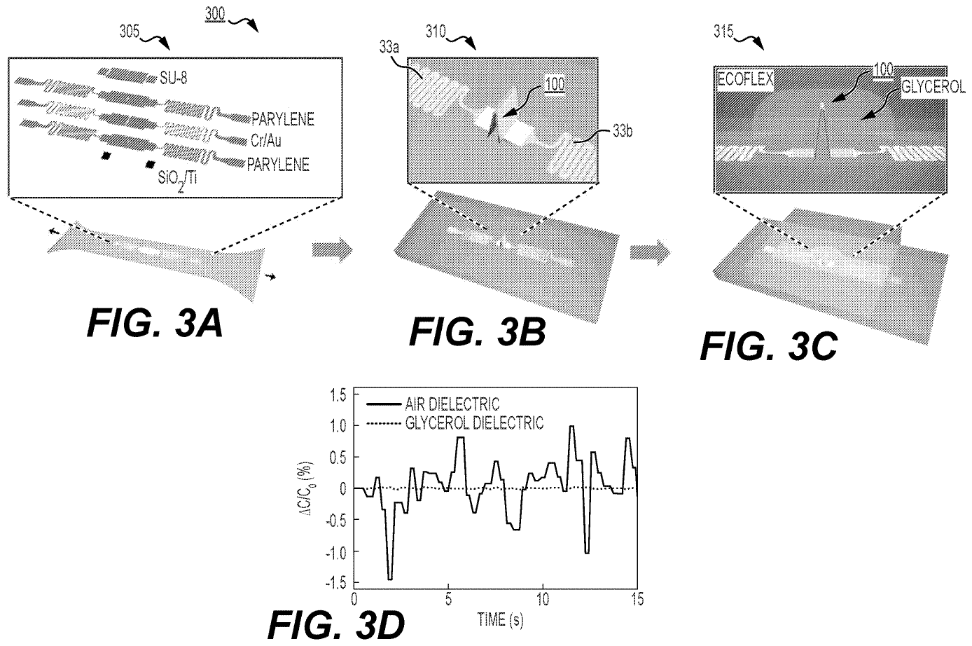

Turning to FIGS. 3A to 3C, examples steps in the fabrication process 300 of system 100 are shown. In FIG. 3A, the process 300 begins with a first step 305 of forming a multi-planar structure, referred to here as the 2D precursor. The 2D precursor can include a first polymer layer (e.g., parylene C layer of approximately 5 μm in thickness), a metal layer (e.g., a lithographically patterned metal layer, here as chromium/gold, 25 nm/200 nm in thickness), and a second polymer layer (e.g., parylene C layer approximately 5 μm in thickness) above it. In some aspects, patterning and etching the polymer layers can create a multi-layer construction of a parylene/metal/parylene structure that can define the multi-panel electrodes 20a, 20b and a pair of traces 33a, 33b extended from each respective electrode. In some aspects, traces 33a, 33b can include a narrow (e.g., approximately 100 μm in width) serpentine traces. In some aspects, traces 33a, 33b can serve as highly stretchable electrical interconnects between the electrodes and external electronics.

In some aspects, a relatively thick (e.g., approximately 35 to 40 μm in thickness), photodefinable epoxy (SU-8 25) coat or cover layer can be included on the uppermost polymer layer (e.g., one of the polymer layers of the multi-layered structure) to provide stiffening at the patterned panels of system 100. In some aspects, coverage of this coat or cover layer (e.g., the SU-8 layer of FIG. 3A) can significantly increase the bending stiffness by a factor of approximately 130 to 175 compared to uncovered regions which can form the structures 27a, 27b, 29. In some aspects, a slit design in the multi-layer structure crease that connects the electrodes 20a, 20b can reduce the bending stiffness of structure 29. In some aspects of step 305, a bilayer of Ti/SiO₂ (e.g., approximately 15 nm/50 nm in thickness) can be deposited on the backside of the 2D precursor through a shadow mask that forms sites for covalent bonding to substrate 10. In some aspects, substrate 10 can be a uniaxially prestretched elastomer substrate (e.g., Ecoflex 00-31). In this example, releasing the prestrain imparts compressive forces that induce buckling of the unbonded regions of the 2D precursor and subsequent folding deformations in the creases.

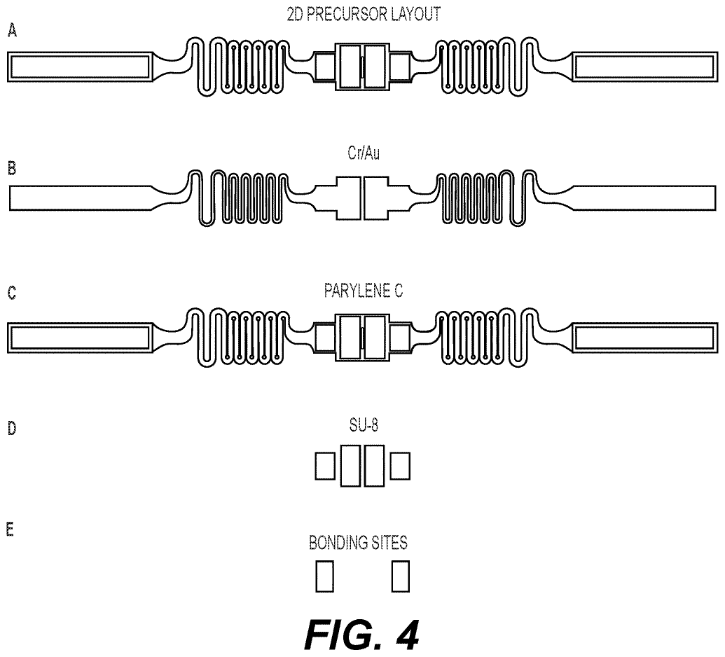

Views A to E of FIG. 4 show certain layouts of example 2D precursor. Specifically, view A of FIG. 4 provides a top schematic view of the stacked 2D precursor. View B provides a top schematic view of an example metal layer of the multi-layer construction (e.g., here a Cr/Au metal layer). View C provides a top schematic view of an example polymer layer of the multi-layer construction. View D provides a top schematic view of an example coat or cover layer (e.g., the SU-8 stiffener layer). View E provides a top schematic view of example bonding sites on the backside of the 2D precursor of FIG. 4.

Turning back to FIG. 3B, step 310 of process 300 is shown. Here, as a result of the mechanically guided assembly process, the panels 25a, 25b form an upright 3D shape (e.g., triangular shape) that is raised from substrate 10. In FIG. 3B, a gap is formed between the two bonding sites S₀ defined by structures 27a, 27b. The gap is determined by the electrode length L and the prestrain εₚᵣₑ:

$${S}_{0} = \frac{2 L}{1 + {ε}_{p r e}} .$$

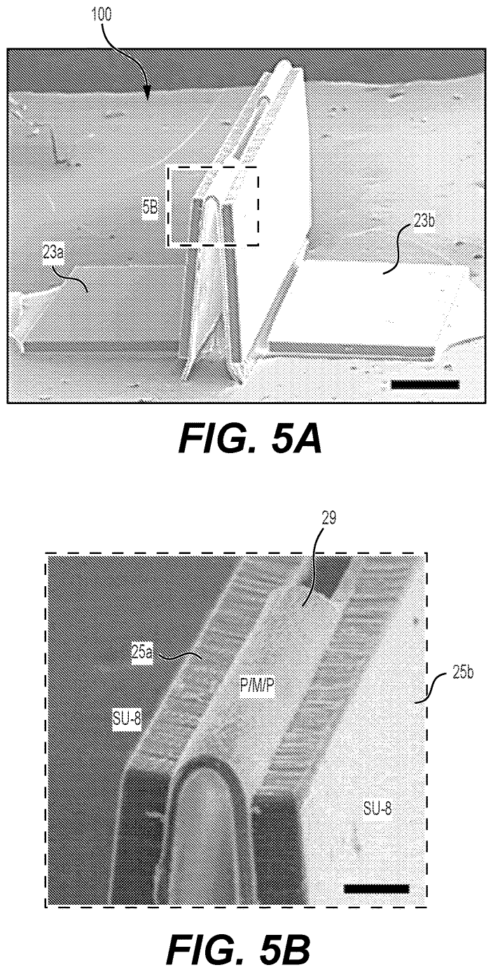

FIG. 5A illustrates an example scanning electron microscopy (SEM) image of an example system 100 structure (scale bar: 200 μm). FIG. 5B illustrates a close-up of section 5B of FIG. 5A (scale bar: 50 μm). As shown in FIG. 5B, due to the small bonding site area (e.g., approximately 500 μm×650 μm) and the high bending stiffness of the previously-described SU-8 layer, panels 23a, 23b of electrodes 20a, 20b bonded on substrate 10 can remain flat without buckling.

In some aspects, following the formation of electrodes 20a, 20b, a cover layer (e.g., one that includes silicon) can be bonded to substrate 10 can encapsulate electrodes 20a, 20b. The cover layer can be formed by a replica molding (e.g., one with a dome-shaped compartment and multiple channels, such as approximately 2.5 mm in width and 0.3 mm in thickness) to accommodate deformations of electrodes 20a, 20b and traces 33a, 33b (see FIG. 3B). In some aspects, filling the compartment and channels of such a replica molding with non-volatile liquid glycerol, as shown in the step 315 of FIG. 3C, can increase the permittivity of the dielectric medium (ε=40~50 at 25° C.° between electrodes 20a, 20b while maintaining flexibility of system 100. In some aspects of step 315, the liquid glycerol dielectric increases the baseline capacitance of the sensor, can lead to an increased signal-to-noise ratio as compared to the air dielectric, as shown in FIG. 3D. FIG. 3D specifically shows a graph that compares the noise levels of two sensors (L=1.0 mm, trapezoidal electrodes) using air and glycerol as the dielectric material. Capacitance values for both sensors were recorded for this example by LCR-6100 at “LOW Speed” option when the example sensor systems remained stationary.

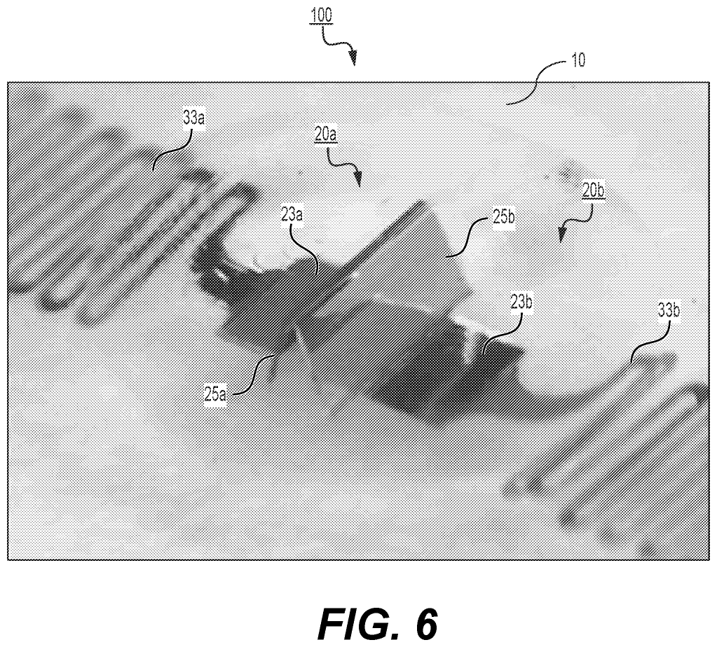

Turning to FIG. 6, an example sensor system 100 is depicted according to one example construction. The depicted electrodes 20a, 20b of FIG. 6 can include an electrode length of approximately 500 μm, a width of approximately 1000 μm, and 3D structure height of approximately 560 μm. In this example, the active sensing area, the 3D electrode area, is approximately 5 mm². The traces 33a, 33b of the serpentine interconnects can include a width of approximately 110 μm and an adjustable length based at least partially on the serpentine shape. The overall dimension of system 100 can be customizable as needed or required. In some examples, system 100 can include a strip shape (e.g., a non-serpentine shape) with a width of approximately 10 mm and a length of approximately 10-50 mm.

In some aspects, system 100 can include a prestrain applied during 3D assembly. Wherein the prestrain εₚᵣₑ can impact the folding angle θ of electrodes 20a, 20b and the corresponding distance between the bonding sites of panels 23a, 23b. In experimental investigations of system 100, FEA that captures the mechanical properties of the constituent materials of the 2D precursor provided accurate predictions of the geometric transformation from 2D to 3D during the assembly process and the resulting structure of electrodes 20a, 20b.

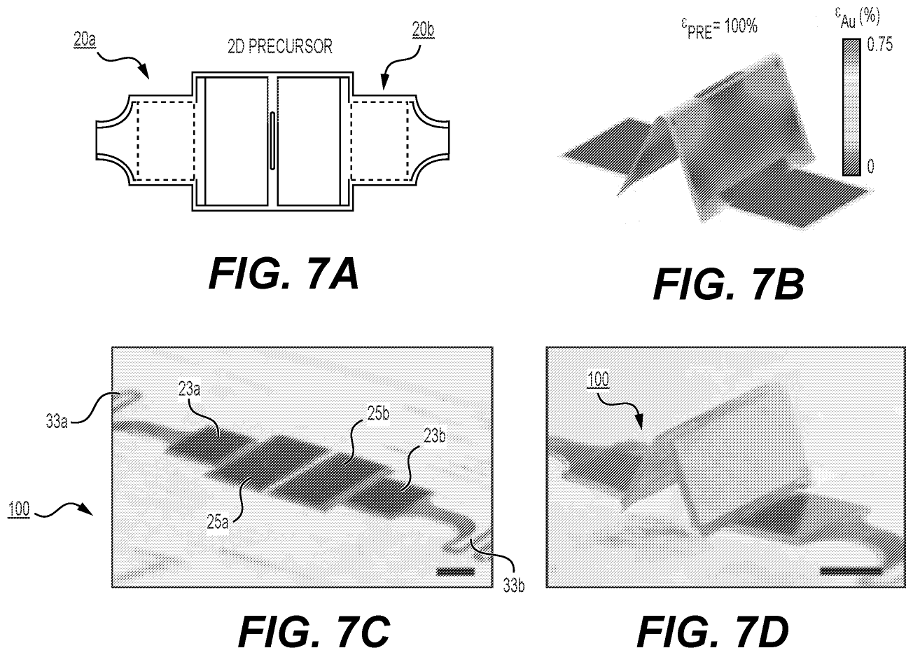

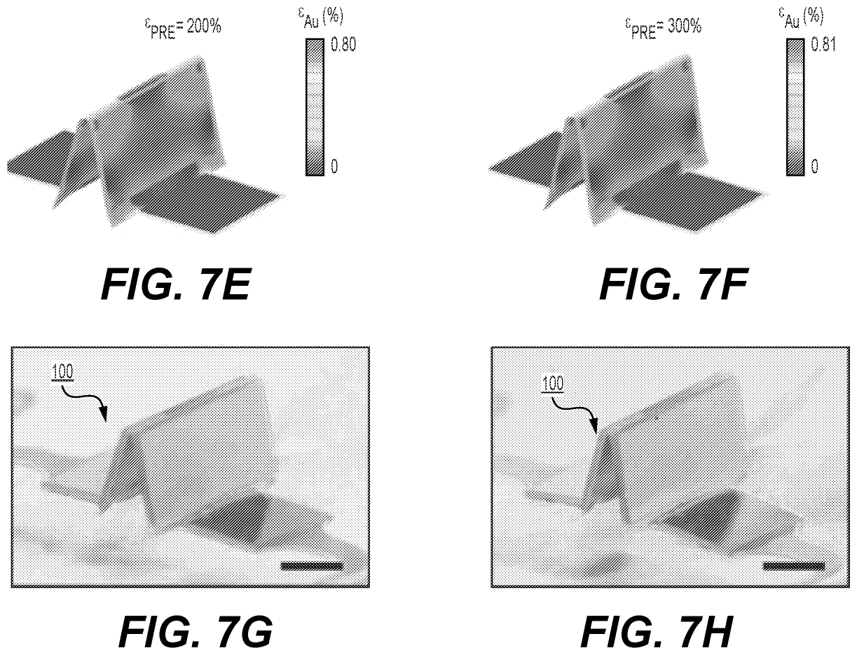

FIG. 7A shows an example shape of electrodes 20a, 20b of a representative top-view of 2D precursor. FIG. 7C shows a perspective view of the system 100 of in a first, relatively flat state. FIGS. 7D, 7G, and 7H show experimental images systems 100 with different folding angles. FIG. 7C shows a perspective with different prestrain levels predicated by FEA strain analysis (FIG. 7B with respect to the configuration of the sensor 100 of FIG. 7D, FIG. 7E with respect to the configuration of the sensor 100 of FIG. 7G, and FIG. 7F with respect to the configuration of the sensor 100 of FIG. 7H).

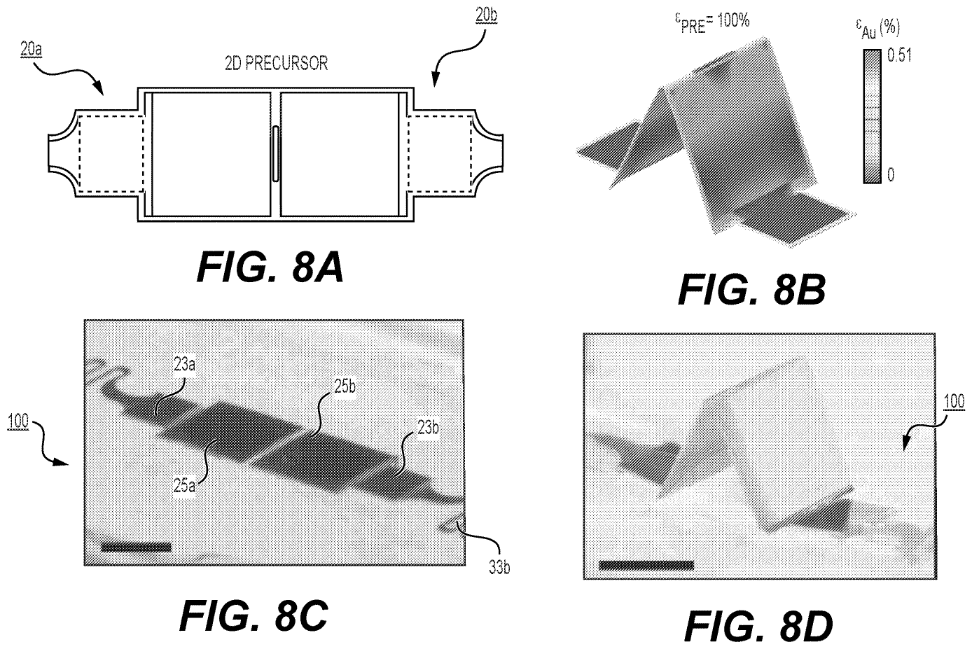

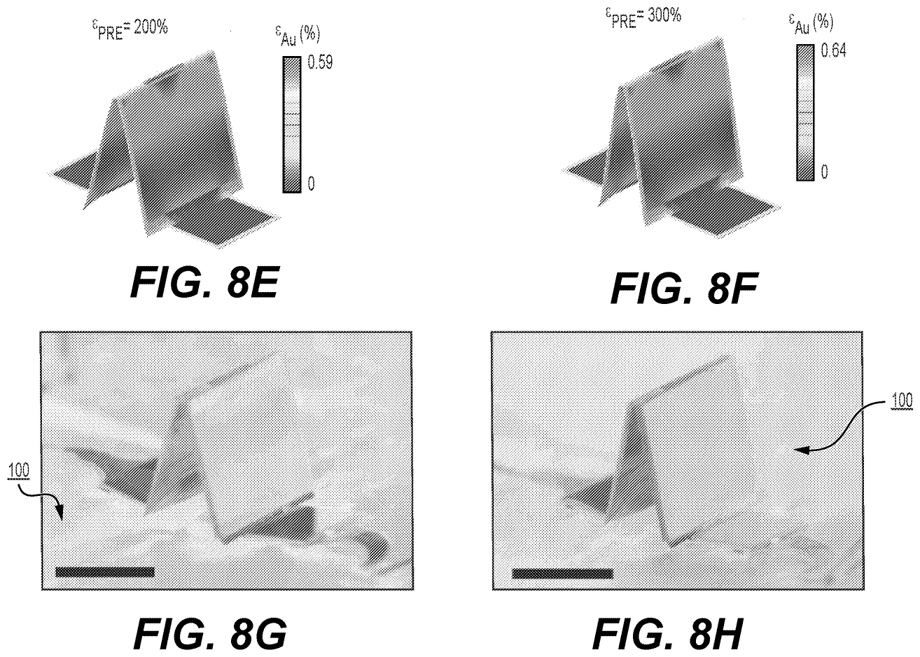

FIG. 8A shows another example shape of electrodes 20a, 20b of a representative top-view of precursors but with a relatively larger electrode length than the example of FIG. 7A (e.g., approximately 1 mm). FIG. 8C shows a perspective view of the system 100 of in a first, relatively flat state. FIGS. 8D, 8G, and 8H show experimental images systems 100 with different folding angles. FIG. 8C shows a perspective with different prestrain levels predicated by FEA strain analysis (FIG. 8B with respect to the configuration of the sensor 100 of FIG. 8D, FIG. 8E with respect to the configuration of the sensor 100 of FIG. 8G, and FIG. 8F with respect to the configuration of the sensor 100 of FIG. 8H).

In addition to geometric modeling, FEA of this example demonstrated quantitative strain distributions in the constituent materials, such as the distribution of the strain in the metal layer (see FIG. 8A). In the example of FIG. 8A, the metal layer is a thin, gold film that exhibited strain levels below the yield strain of deposited Au thin films even at prestrain, εₚᵣₑ=300%. In some aspects, this is due to the position of the metal layer near the mechanical neural plane of the multi-layer construction (e.g., parylene/metal/parylene trilayer) at structures 27a, 27b, 29 and the panel designs. In some aspects, the maximum equivalent strain appeared near the corners of structure 29, which can be slightly above the yield strain but highly localized. The prestrain also created an upper bound for the maximum uniaxial strain the sensor system 100 is able to measure (εₘₐₓ=εₚᵣₑ), beyond which the electrodes 20a, 20b are fully unfolded and susceptible to fracture upon further stretching.

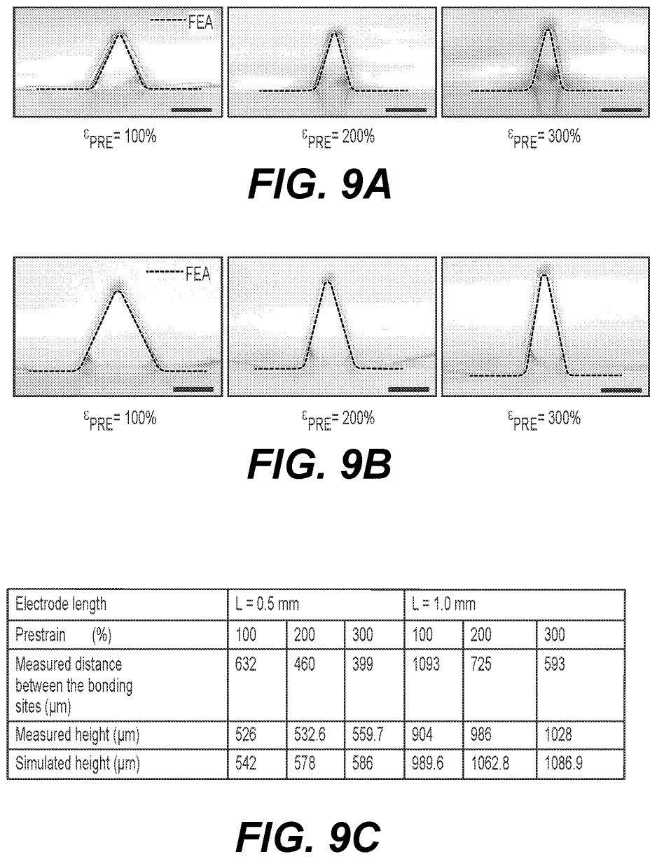

In some aspects, quantitative measurements of heights of the electrodes 20a, 20b electrodes from FEA (dashed-line) and experiments (non-dashed) are shown in FIGS. 9A and 9B. Specifically, FIGS. 9A and 9B show sideview optical images and the corresponding simulated profiles of the foldable 3D electrodes 20a, 20b of this disclosure in different positions. In the depicted examples, electrodes 20a, 20b are non-parallel-plate capacitor with different prestrain, including FIG. 9A depicting a system with approximately 0.5 mm electrode length and FIG. 9B depicting a system with approximately 1 mm electrode length. In FIG. 9A, the scale bars are approximately 250 μm and in FIG. 9B the scale bars are approximately 500 μm. FIG. 9C provides a table that compares the heights of foldable 3D electrode structures with two different electrode length designs (FIGS. 9A and 9B) measured in experiments and FEA, whereby FIG. 9C indicates relatively high agreement with less than 6.5% relative error. The errors are likely due to imperfections of the fabrication process associated with the experiments of FIGS. 9A to 9B, such as slight misalignment of the bonding sites with the electrode pattern.

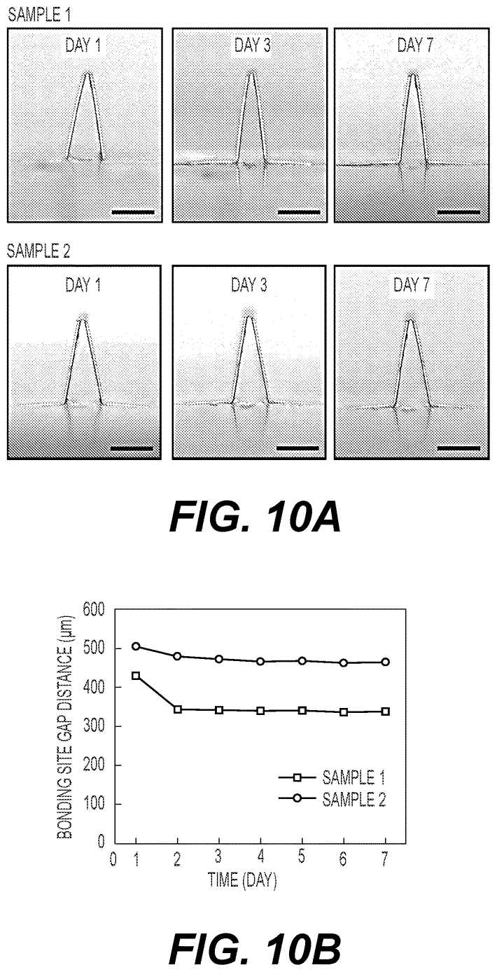

In some aspects, excessive bonding can occur after the assembly process but quickly disappear due to partial delamination, resulting in a stable 3D structure after approximately 1 to 2 days as shown in the examples of FIG. 10A. Specifically, FIG. 10A shows example sideview images of two sample electrodes on day 1, day 3, and day 7, respectively, after being formed according to the mechanically guided assembly process of this disclosure. FIG. 10B shows a graph comparing distances of each sample of FIG. 10A as between the two bonding sites measured from day 1 to day 7.

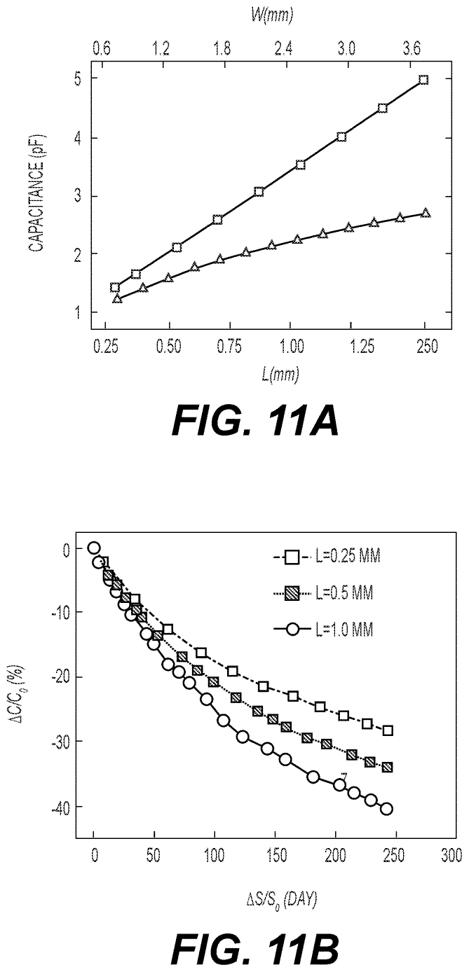

FIG. 11A shows a graph comparing capacitance versus electrode length of each sample of FIG. 10A. FIG. 11B shows a graph comparing capacitance change versus applied strain of each sample of FIG. 10A. As shown in these comparisons, the electrode dimensions influence the initial capacitance of the electrodes 20a, 20b and the capacitance change during the folding/unfolding processes. With fixed prestrain, the capacitance was demonstrated to increase with both increased electrode width W and length L. In the demonstrated FEA, a linear trend for electrode width was observed but the slope was smaller for increased electrode length above a certain value with the crease length fixed (e.g., approximately 1 mm for 80 μm crease length under 300% prestrain, as shown in FIG. 11A). FIG. 11B demonstrated the simulated relative capacitance change of sensors with different electrode lengths as a function of applied strain at the bonding sites, ΔS/S₀. It was observed that sensor systems 100 of this disclosure with an electrode length of 1.0 mm have a larger capacitance change compared to those with shorter electrode lengths, such as 0.5 mm and 0.25 mm. The gauge factor of the strain sensor, defined as

$$G F = \frac{Δ C / {C}_{0}}{ε} ,$$

was −0.11, −0.21, and −0.25 for L=0.1, 0.5, and 1.0 mm, respectively, at 100% local strain. While larger electrode lengths resulted in larger baseline capacitance and higher strain sensitivity, submillimeter electrode lengths were chosen for sensor miniaturization.

In some aspects, the traces 33a, 33b (e.g., traces which can be those depicted serpentine metal traces) can provide stretchable electrical interconnects, which can be critical for robust electrical sensor readout. In the examples of FIGS. 8A to 11B, such traces were adopted, including a serpentine pattern with approximately 110 μm linewidth, approximately 900 μm length, and approximately 180° arc angle.

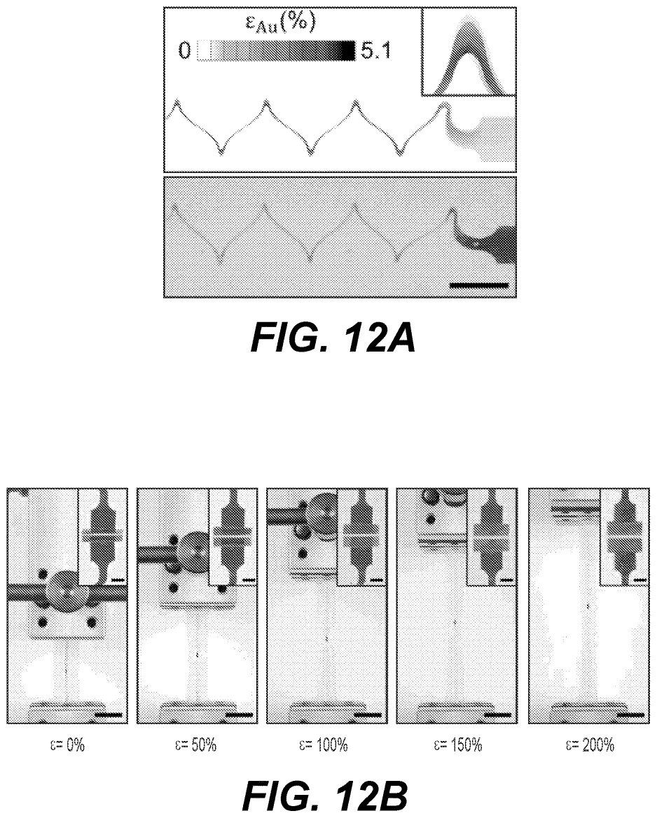

FIG. 12A shows a graphic summarizing FEA along with experimental images of example traces of the analyzed example sensor system under stretching, with the strain in the metal layer of the trilayer construction shown in the FEA contours. Specifically, FIG. 12A shows the comparison between FEA and experimental results of the trances upon 200% stretching and the results indicate a strong agreement between the stretched shapes. The illustrated scale is 500 μm in A and 1 mm in D. Based on FIG. 12A, it was observed that traces 33a, 33b can accommodate large uniaxial stretching without fracture due to their out-of-plane buckling and twisting inside the channels. The placement of the metal layer (e.g., here the gold layer) in the mechanical neural plane of the multi-layer construction also minimized strain caused by bending. The maximum equivalent strain in the metal layer was approximately 5.1% when 200% stretching was applied, located only at the inner corners of the curved traces (e.g., the illustrated serpentine example). The majority of the metal traces remained within the fracture limit consistent with experimental observations that 200% stretching does not cause electrical failure of traces.

FIG. 12B shows images of another sensor system of this disclosure in a relatively long strip (e.g., approximately 40 mm in length) subjected to uniaxial stretching with nominal strains, as shown moving from the denoted views left to right in FIG. 12B which relate to 0%, 50%, 100%, 150%, and 200% applied to the sensor system. The example images of FIG. 12B capture the unfolding of the electrodes 20a, 20b from between different folding states at the center of the sensor strip.

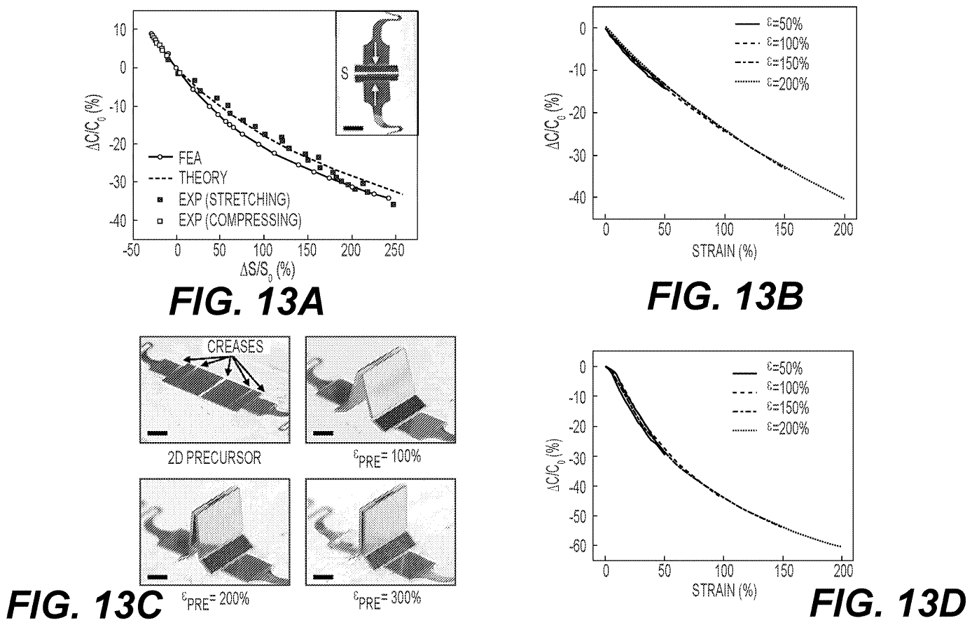

FIG. 13A illustrates a graphical characterization of the strain sensing range and the corresponding degrees of hysteresis of the sensors. Specifically, FIG. 13A illustrates simulation, analytical, and experimental results for the relative change in bonding site distance and the corresponding relative capacitance change of the example strain sensor system 100. C₀ denotes the capacitance with a bonding site distance S=210 μm. In some aspects, the angled electrodes of the example strain sensor systems of this disclosure are able to unfold and fold in response to stretching or compression along the direction of the bonding which can cause decrease or increase in the capacitance, as shown in FIG. 13A. The graph here summarizes measurements of the relative capacitance change ΔC/C₀ as a function of the relative change in the bonding site distance (e.g., the local strain at the bonding sites ΔS/S₀). C₀ in FIG. 13A represents the sensor capacitance without deformation, and experimental measurements involve both stretching and compressing the sensor. It was observed therefore that results from FEA of the 3D electric field were consistent with experimental measurements. FIG. 13B is a graph that compares relative capacitance change of a representative sensor (L=0.5 mm) with the example system 100 during uniaxial loading and unloading at 50%, 100%, 150%, and 200% applied strain.

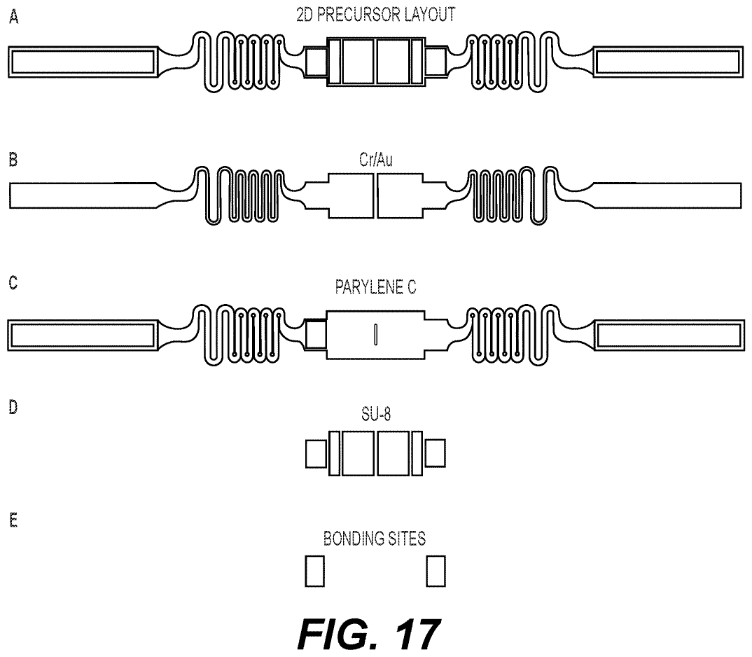

FIG. 13C shows optical images of the precursor of a sensor system of this disclosure that includes a multi-crease electrode design (e.g., 5 creases as in the example here) and the resulting electrodes formed with different prestrain. Here, FIG. 13C shows an example of a multi-crease structure where two additional creases are added to the large panels 23a, 23b. The corresponding 2D precursor design appears in views A to E of FIG. 17. Different prestrain prior to the compressive buckling process leads to distinct 3D shapes, from multi-segment non-planar shapes to fully closed, vertically aligned plates due to the presence of the additional foldable panels next to the middle panels. This contrasts with the basic three-crease design in FIG. 8A where 300% prestrain results in an angle of approximately 22~24° between the two folded plates. FIG. 13D shows the relative capacitance change of a representative sensor system with the five-crease electrode design and 300% prestrain. Stretching of a fully closed electrode configuration causes a faster decrease in Cᵢₙ, the main component of the total capacitance, due to a smaller folding angle θ. As a result, this multi-crease electrode design leads to a larger gauge factor (GF=−0.44 at 100% strain and GF=−0.30 at 200% strain) as compared to that of the basic design.

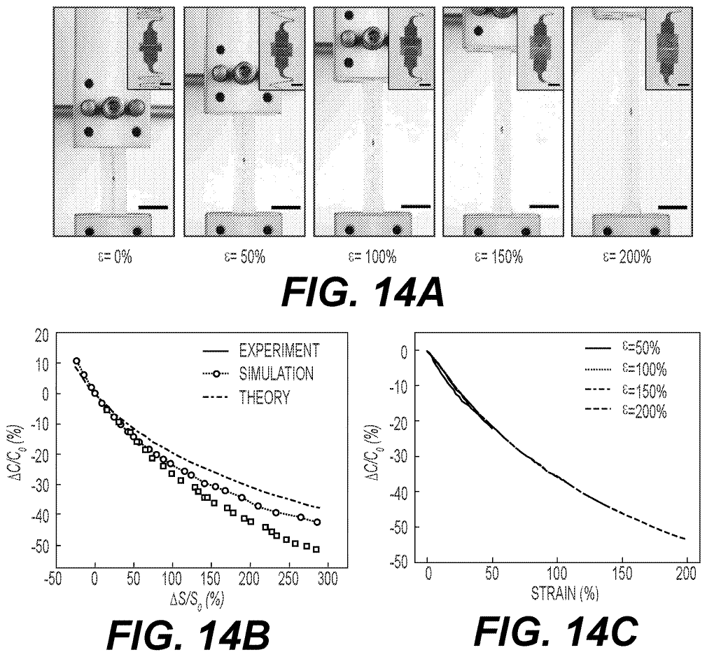

Stretching tests for sensors with electrode length of 1 mm were also shown in FIGS. 14A to 14C. Specifically, FIG. 14A shows example images of another example sensor system of this disclosure with approximately 1 mm in electrode length subjected to uniaxial stretching with nominal strains at 0%, 50%, 100%, 150%, and 200%, with insets showing close-up views of the electrodes. FIG. 14B shows a graph that depicts simulated, analytical, and experimental results for the relative change in bonding site distance and the corresponding relative capacitance change of the sensor system of FIG. 14A. The sensor system of FIG. 14B has an approximate electrode length of L=1 mm and approximate width of W=1 mm. C₀ corresponds to the capacitance with a bonding site distance of S₀=403 μm. FIG. 14C shows a graph demonstrating relative change in capacitance of the sensor system of FIG. 14A, with different prestrain, during loading and unloading at applied strains of 50%, 100%, 150%, and 200%, which demonstrated similar decreasing trends among simulation, measurement, and analytical results. It was observed that the relative capacitance change from analytical results is smaller at large strain as compared to simulation and experiment results.

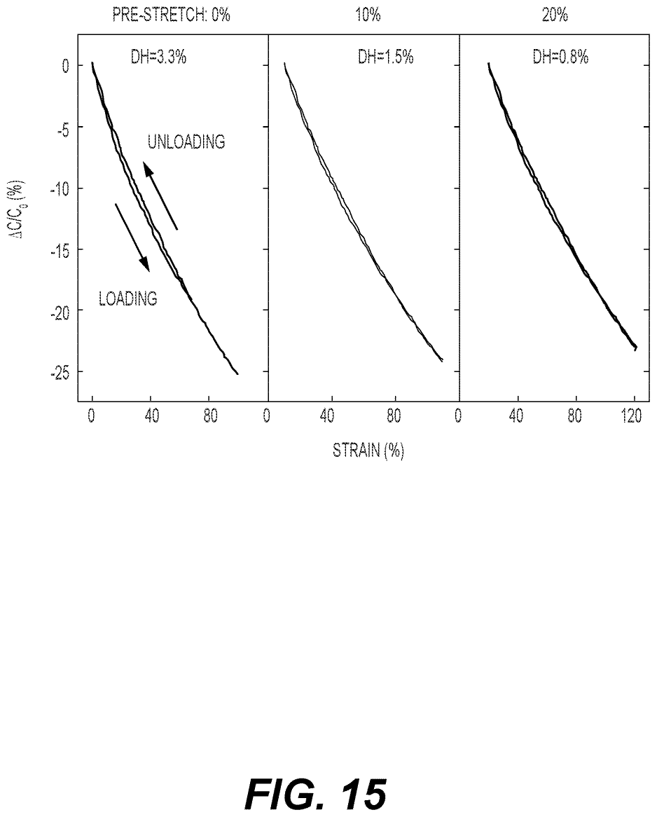

Degree of hysteresis (DH) is an important performance parameter for strain sensors as it affects their accuracy and repeatability. It was observed that the strain sensor systems of this disclosure exhibited relatively low levels of DH. Specifically, FIG. 13B shows the loading and unloading curves of a representative sensor (L=0.5 mm, W=1.0 mm) stretched up to 200% strain at a strain rate of 10% s⁻¹. The sensor system showed a GF=−0.25 at 100% strain and GF=−0.20 at 200% strain which was highly consistent at different strains. The DH values measured from the loading/unloading loops were approximately 4.88±1.67% at ε=50%, 2.35±0.63% at ε=100%, 1.84±0.68% at ε=150%, and 1.19%±0.58% at ε=200% (each measured from 5 samples). Given the reversible nature of folding/unfolding deformations of the electrodes of the analyzed sensor system, it was observed that the measured sensor hysteresis originated from the viscoelasticity of the stretchable substrate. The decreasing DH with increasing strain range demonstrated that prestretching the sensor prior to strain sensing led to reduced DH for the same applied strain. For example, the measured DH from a sensor without prestretching for 100% applied strain was approximately 3.32% and it decreased to 1.50% for 10% prestretching and 0.79% for 20% prestretching, as shown in FIG. 15 where the DH values were observed as approximately 3.3%, 1.5%, and 0.8%, respectively.

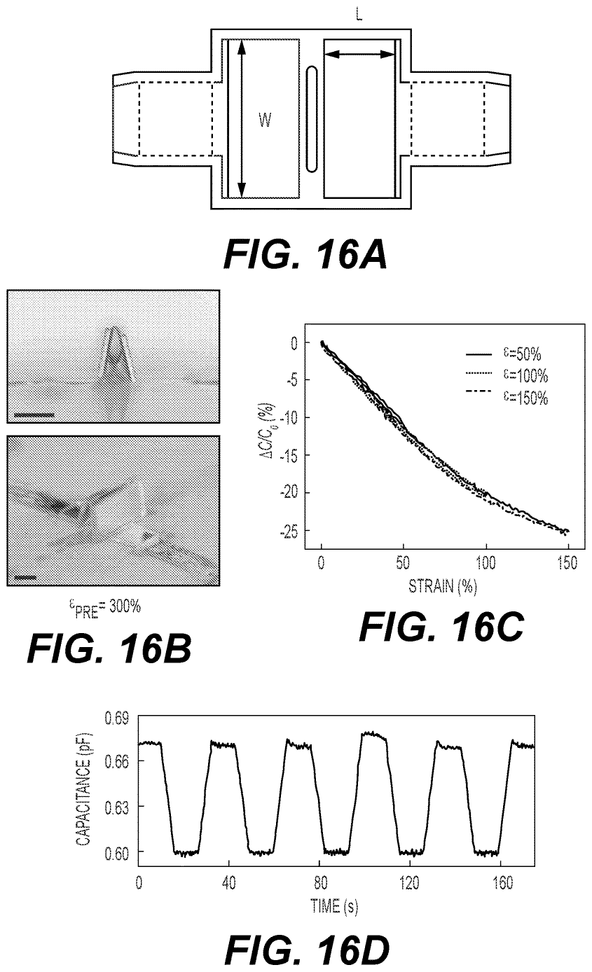

FIGS. 16A to 16D show another example sensor system of this disclosure with an approximate length, L=0.25 mm, and approximate width, W=0.55 mm. Specifically, FIG. 16A depicts a top view of a two-dimensional layout of the sensor system of this example embodiment. The dashed regions represent bonding sites of the sensor system to the related substrate (e.g., area of approximately 250 μm×250 μm). FIG. 16B shows optical images of the front and angled view of the electrodes of the sensor system formed by compressive buckling with 300% prestrain. FIG. 16C shows a graph depicting relative capacitance change of the sensor system of FIG. 16A during uniaxial loading and unloading at 50%, 100%, and 150% applied strain. FIG. 16D shows a graph depicting capacitance change during cyclic 50% uniaxial loading and unloading. As shown, a reduction in electrode dimensions was observed to lead to smaller baseline sensor capacitance, making it more susceptible to noise and parasitic capacitance. It was also observed that further miniaturization presented challenges in precise control of the bonding regions between the electrodes and the substrate, often leading to increased hysteresis.

Views A to C of FIG. 17 illustrate schematics of an example sensor system of this disclosure that includes precursor of a five-crease example embodiment. View (A) illustrates an overview of the 2D precursor layouts, while View (B) shows a layout of the metal layer (e.g., here a Cr/Au metal layer). View (C) shows a layout of an example polymer layer (e.g., here a parylene C layer). View (D) shows a layout of an example stiffener layer (e.g., here SU-8 stiffener layer). View (E) shows a layout of an example of the bonding sites on the backside of the precursor.

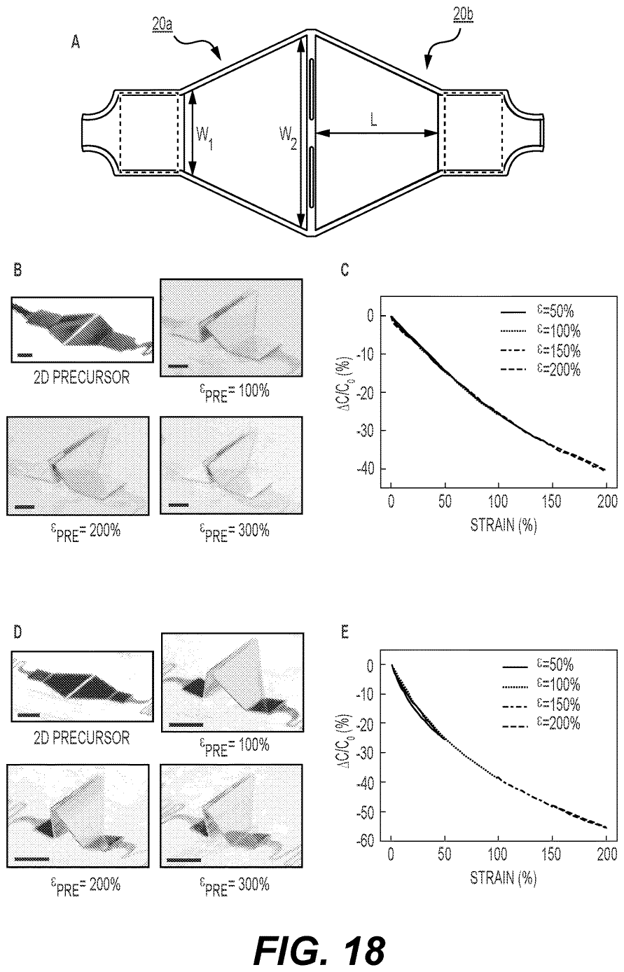

Besides different structures 27a, 27b, 29, variations in the shape of electrodes 20a, 20b are contemplated in this disclosure. View (A) of FIG. 18 shows one such example sensor system with multi-creased electrodes 20a, 20b that are trapezoidal-shaped and foldable (electrode length L=0.5 mm and L=1.0 mm). Those regions encircled by dashed lines represent bonding sites to the corresponding substrate of the sensor. View (B) of FIG. 18 shows example optical images of the electrodes 20a, 20b of view (A) with L=0.5 mm formed by compressive buckling with different prestrain. View (C) of FIG. 18 shows a graph comparing relative capacitance change of a representative sensor based on the trapezoidal electrodes of view (A), where L=0.5 mm, W₁=0.7 mm, W₂=1.5 mm, at 300% prestrain, during uniaxial loading and unloading at 50%, 100%, 150%, and 200% applied strain. View (D) of FIG. 18 shows optical images of the example electrodes of view (A) with L=1 mm formed by compressive buckling with different prestrain. View (E) of FIG. 18 is a graph that compares relative capacitance change of a representative sensor based on trapezoidal electrodes (L=1 mm, W₁=0.7 mm, W₂=1.7 mm, 300% prestrain) during uniaxial loading and unloading at approximately 50%, 100%, 150%, an d 200% applied strain. With each of views (A) to (E) taken together, the example sensor system of view (A) with approximately L=0.5 mm was analyzed and observed to exhibit similar capacitance responses (GF=−0.26 at 100% strain) as that based on the previously-described rectangular-shaped electrode. In contrast, the sensor with approximately L=1.0 mm shows higher sensitivity (GF=−0.39 at 100% strain) than that (GF=−0.36 at 100% strain) of the example sensor with rectangular electrode design and the same electrode length, likely due to the relatively larger contribution of the upper portion of the folded electrodes in the total capacitance change.

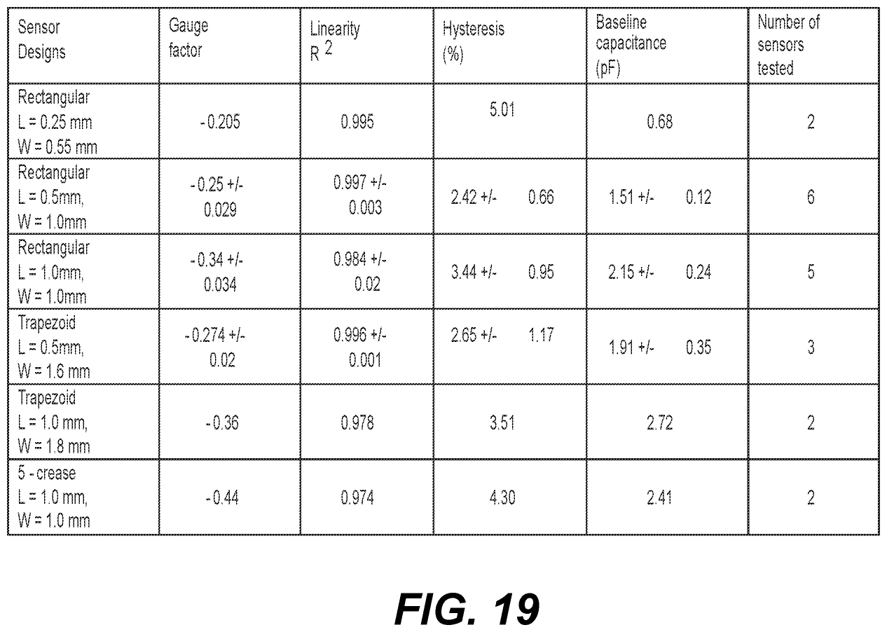

The table shown in FIG. 19 summarizes performance parameters of sensors with different electrode designs under approximately 100% strain. It was observed that increasing crease in L from 0.25 mm to 1 mm can lead to increased sensitivity, with slight decrease in the linearity due to more fringe capacitance change introduced at larger bonding site gaps. In some aspects, it was observed that relatively larger electrode area can increase the baseline capacitance, which reduces the influence of parasitic capacitance and measurement noise.

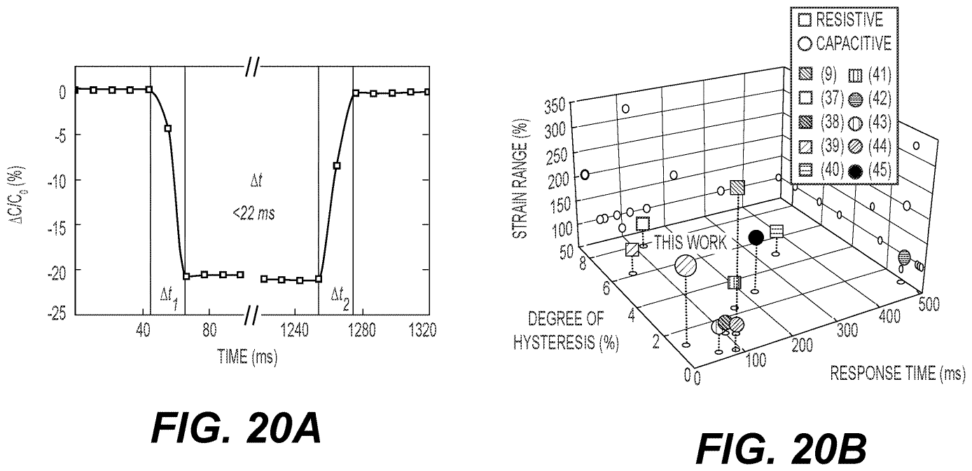

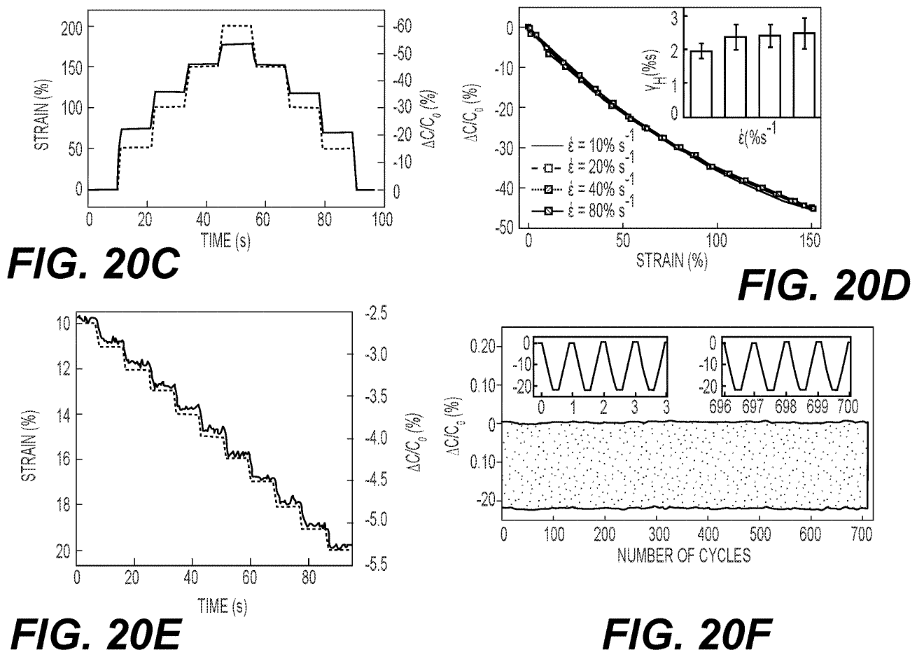

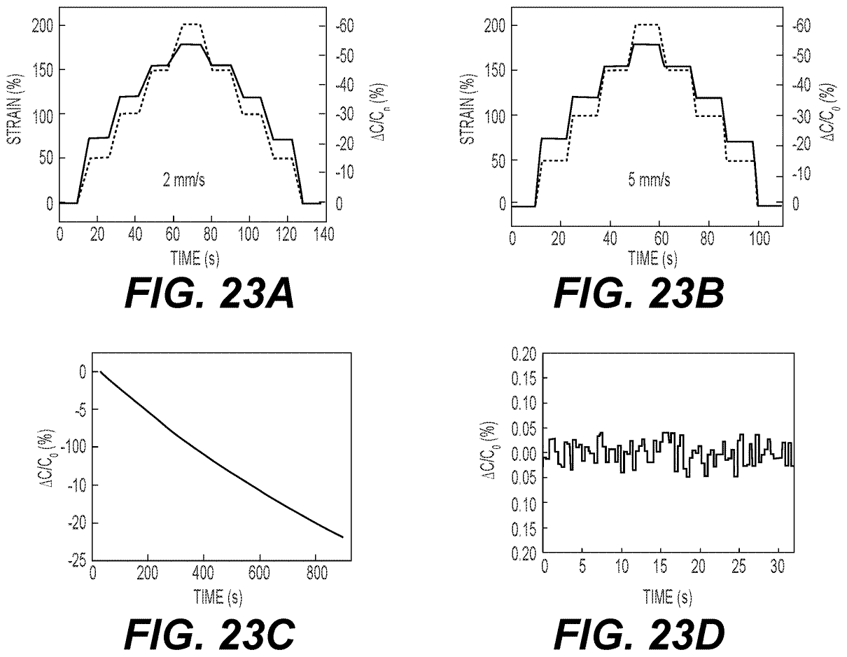

In addition to the large strain range and small hysteresis, the sensor system of this disclosure with its foldable electrode-based capacitive sensors are advantageous for a number of additional reasons, as shown in FIGS. 20A to 20F. Specifically, FIG. 20A depicts real-time response of one example strain sensor of this disclosure subjected to a 100% step strain, showing the response time and recovery time. As can be seen, without the presence of viscoelasticity in the active sensing materials, the sensor has fast response to deformation. FIG. 20B depicts a three-dimensional graphical comparison of previously reported example strain sensors in the sensor strain range, DH, and response time. FIG. 20C is a graph that compares capacitance response of a representative sensor, approximate L=1 mm, under a series of step-up strain of 50% to a maximum of 200% followed by step-down strain to the initial state. FIG. 20C shows an exemplary sensor response to a step-and-hold test where the observed sensor system was subject to alternating stepwise stretching with a 50% strain step size at 10 mm/s (approximately 42% s⁻¹) and holding (approximately 10 s). The applied strain increases to a maximum of 200% strain then decreases to approximately zero. No obvious creeping effect was observed in the example sensor system readout throughout the test. Similar tests for other stretching speeds appear in FIGS. 23A and 23B, which show graphs that compare capacitance response of a representative sensor (L=1 mm) subjected to a series of step-up strain of 50% to a maximum of 200% followed by step-down strain to the initial state. In FIG. 23A, the stretching and releasing rates were approximately 2 mm/s (strain rate: 8.3% s⁻¹) in FIG. 23B the stretching and releasing rates were approximately 5 mm/s (strain rate: 20.8% s⁻¹).

FIG. 20D is a graph that compares capacitance response of the example sensor system (L=1 mm) stretched to 150% strain at strain rates of 10% s⁻¹, 20% s⁻¹, 40% s⁻¹, and 80% s⁻¹. As shown, the bar plot shows the DH at different strain rates. The largely overlapping response curves indicate velocity-insensitive sensor performance. Due to higher energy dissipation at high strain rates, hysteresis was observed to increase from 1.96% to 2.48% when the strain rate increased from approximately 10% s⁻¹ to approximately 80% s⁻¹. The maximum difference at any specific strain is within 1.0% in AC/C, when the sensor is stretched at 150% strain with strain rates of 10% s⁻¹, 20% s⁻¹, 40% s⁻¹, and 80% s⁻¹. FIG. 20E is a graph that compares relative capacitance change of the example sensor system (L=0.5 mm) under increasing strain with 1% strain increments. FIG. 20F is a graph that shows relative capacitance change of a representative sensor (L=0.5 mm) over 700 loading/unloading cycles at 100% strain, with close-up views at the beginning and end of the test.

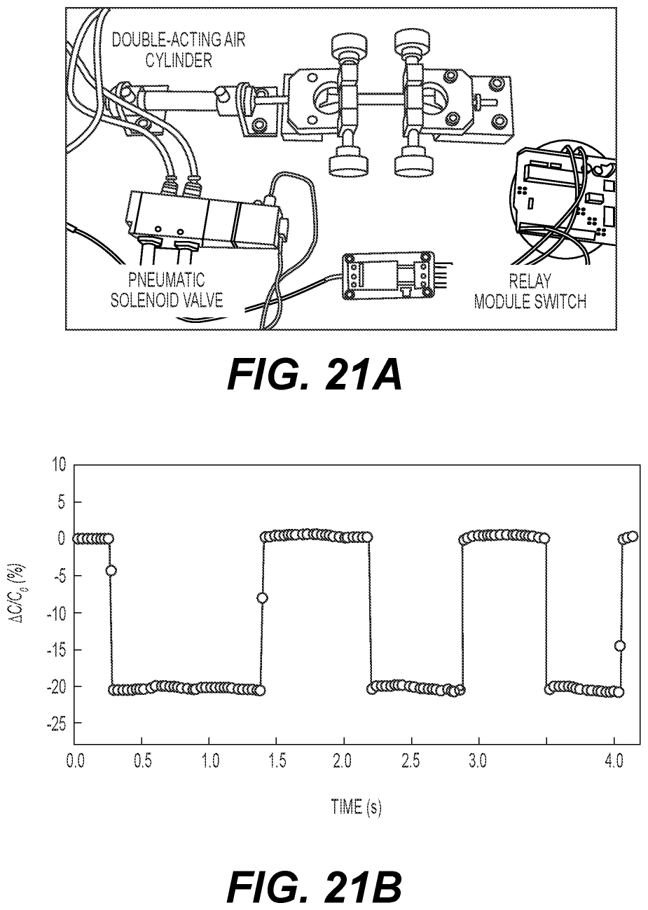

In another analysis, a quick stretching action (100% strain) was applied to the sensor using a custom actuation setup synchronized with capacitance measurement. The test setup for this is shown in FIG. 21A. FIG. 21B is a graph that compares capacitance responses from for the example strain sensor system tested with the setup of FIG. 21A, having L=0.5 mm and having been subjected to 100% stretching and release for multiple cycles at fast speeds. As shown, the investigated strain sensor system exhibited both response time Δt₁ and the recovery time t₂ of less than approximately 22 ms, estimated from the sampling rate of capacitance measurement. The comparison depicted in FIG. 21B evidences that capacitance responses to multiple quick stretching and releasing actions demonstrate the consistency in example strain sensor system of this disclosure is configured for fast response and recovery time.

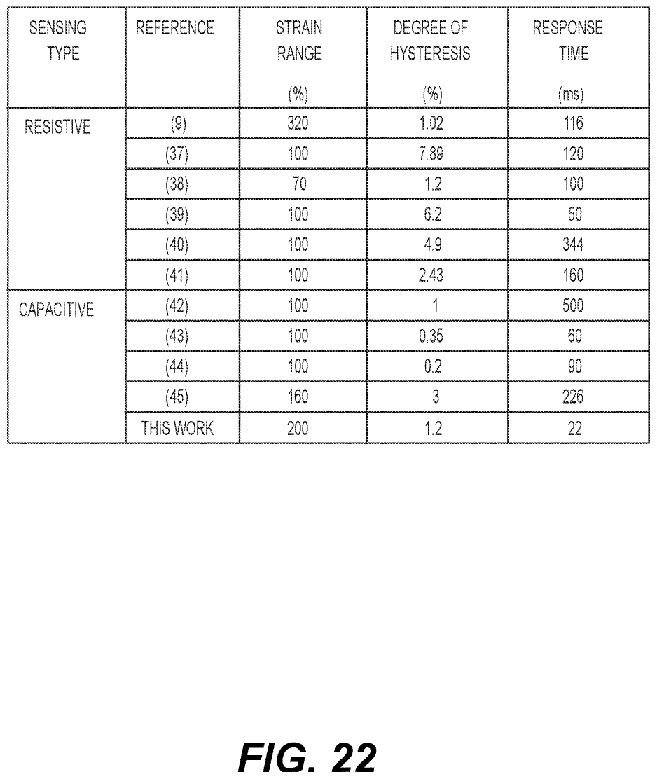

The combination of large strain range (200%) with low DH (1.19%) and fast response (<22 ms) distinguishes the strain sensor systems of this disclosure from other stretchable strain sensors. FIG. 20B and the table of FIG. 22 compare example sensor systems of this disclosure with prior resistive and capacitive strain sensors on the important sensor performance parameters. In this comparison, the herein disclosed sensors demonstrated relatively low levels of DH and response time among all strain sensors with large (e.g., approximately >100%) strain range including examples not shown in FIG. 20B, which can be critical for accurate and dynamic strain sensing. The strain range of the sensor systems of this disclosure is also large among capacitive strain sensors owing to the unique 3D mesostructured electrode design as compared to conventional parallel-plate capacitors. The strain range of the herein disclosed sensor systems can be extended readily to be above 200% by increasing the prestrain in the mechanically guided assembly process for forming the electrodes 20a, 20b and optimizing the serpentine traces 33a, 33b. The low hysteresis and small response/recovery time of the herein disclosed sensor systems allow the sensor systems to measure fast, dynamically changing deformations.

In some aspects, the herein disclosed example strain sensor systems demonstrated relatively low hysteresis and stable structure that allow the detection of small strain changes (e.g., approximately <1%) over 100% strain range using standard capacitance measurement units (see, e.g., FIG. 20E and FIG. 23C, which compares relative capacitance change of a representative sensor (approximate L=0.5 mm) under stretching up to approximately 100% strain with fine stepping profile [e.g., step size of 1% strain]). It was also observed that for each approximate 1% strain increment, the average relative capacitance change was 0.22% and the signal-to-noise ratio was approximately 60 (noise signal appears in FIG. 23D). FIG. 23C indicates distinguishable capacitance signal for small strain changes and that the investigated strain sensor systems exhibit repeatable responses to 100% strain over 700 loading and unloading cycles (see FIG. 20F). The maximum variation in the relative capacitance change during these cycles is 0.8%, owing to the structure stability of the electrodes (e.g., electrodes 20a, 20b) and the robust bonding of the electrodes to the substrate. The sensor systems were also observed to exhibit stable performance over 15 days. The hysteresis remains mostly unchanged with a slight decrease (~5%) in sensitivity.

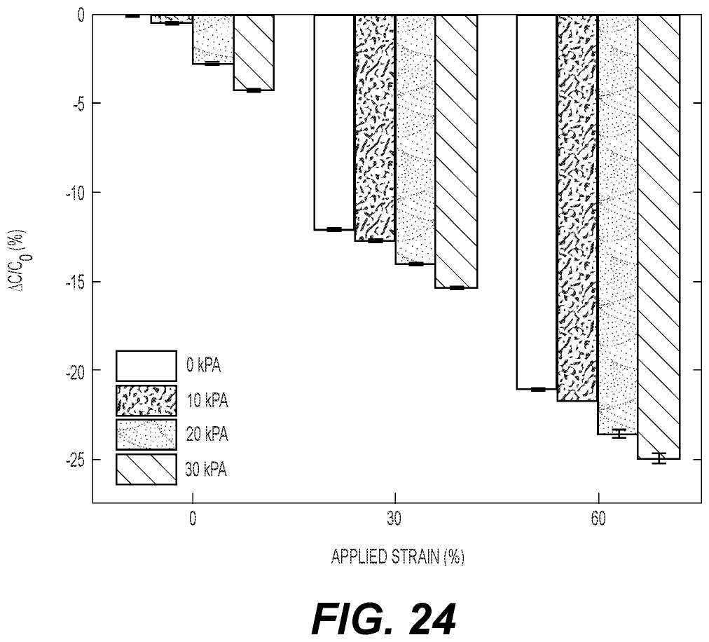

In some aspects, the example strain sensor systems of this disclosure can include an upper cover layer (e.g., a top silicone cover) and liquid glycerol can help reduce the deformation of the electrodes under normal or shear stress. Characterization and discussion of the influence of normal pressure on strain sensing appear in FIG. 24, which show a graph comparing capacitance response of an example sensor system of this disclosure stretched to different levels (0%, 30%, and 60%) under different static, persistent normal pressures. The scale bars of FIG. 24 related to 1 cm.

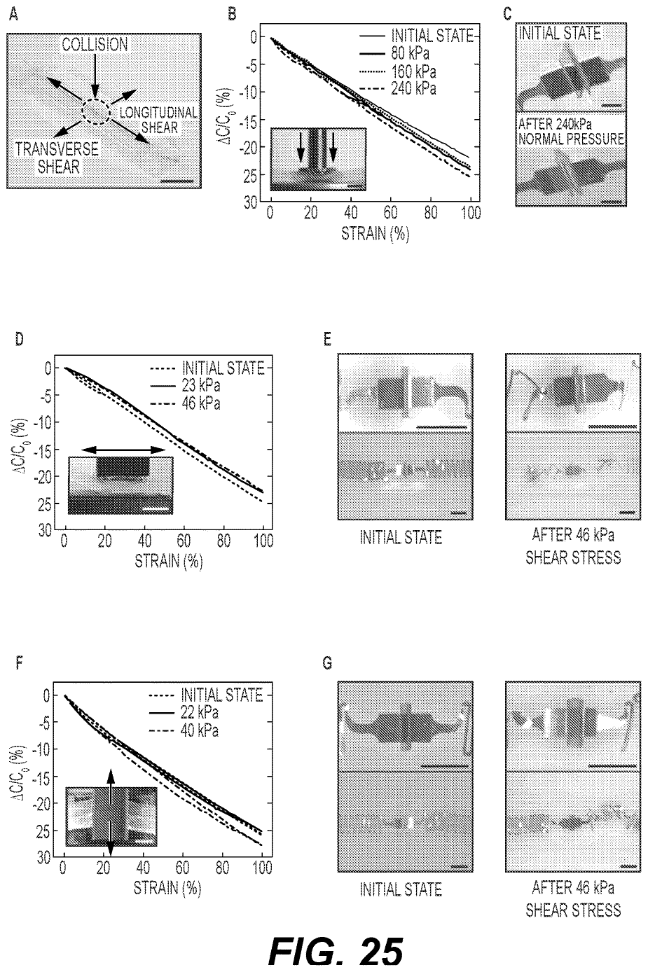

A detailed characterization of the example strain sensor system's mechanical robustness against collisions and abrasions is summarized in views (A) to (G) of FIG. 25. Specifically, view (A) of FIG. 25 shows loading directions for collision and abrasion tests on an example strain sensor system. View (B) of FIG. 25 is a graph that compares relative capacitance changes of the example strain sensor systems under 100% strain before and after applying peak normal pressures of approximately 80 kPa, 160 kPa, and 240 kPa. View (C) of FIG. 25 shows images of the electrodes of the analyzed example strain sensor systems in an initial state and after applying a peak normal pressure of approximately 240 kPa. The pressure was applied at a speed of approximately 20 mm/s. View (D) of FIG. 25 illustrated relative capacitance changes of the sensors under 100% strain before and after applying peak shear stresses of 23 kPa and 46 kPa in the example strain sensor system's longitudinal direction. View (E) of FIG. 25 shows images of the electrodes and traces of example strain sensor systems in the initial state and after applying a peak shear pressure of approximately 46 kPa in the sensor's longitudinal direction. View (F) of FIG. 25 is a graph that compares relative capacitance changes of the example strain sensor systems under 100% strain before and after applying peak shear stress of approximately 22 kPa and approximately 40 kPa in the sensor's transverse direction. View (G) of FIG. 25 shows images of electrodes and traces of example strain sensor systems in the initial state and after applying a peak shear stress of approximately 40 kPa in the transverse direction.

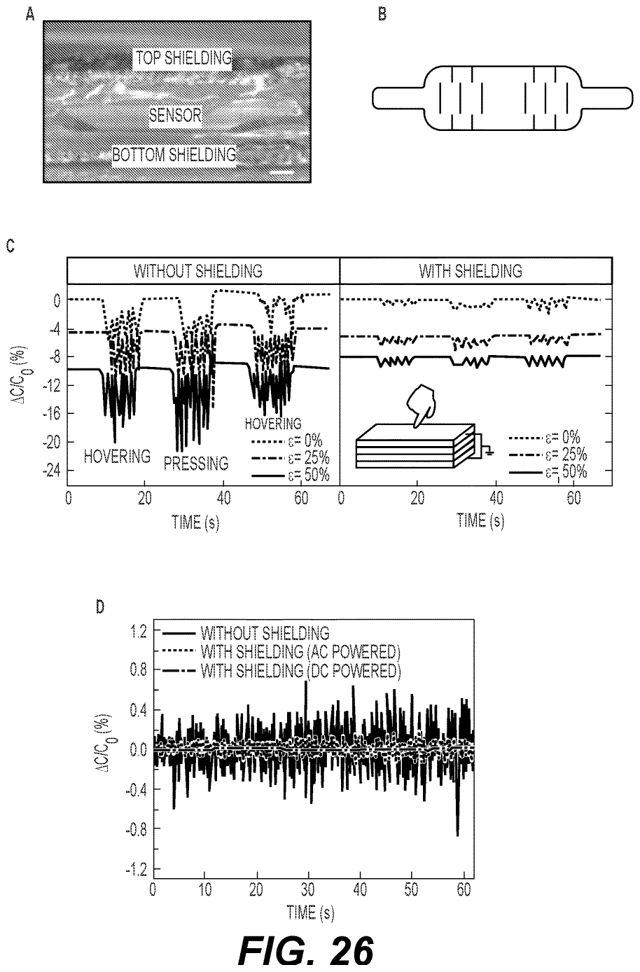

In some aspects, the example strain sensor systems of this disclosure without electromagnetic shielding demonstrated noise levels of approximately 8% relative capacitance change when a human finger was hovering above or pressing the sensor, as shown in views (A) to (D) of FIG. 26, which describe aspects of design and performance of example strain sensor systems of this disclosure with electromagnetic shielding. View of (A) of FIG. 26 shows images (cross-sectional view) of an example strain sensor with two electromagnetic shielding layers on the top and bottom. View (B) of FIG. 26 depicts example cut design in the electromagnetic shielding layers. View (C) of FIG. 26 is a graphical comparison of sensor responses without and with electromagnetic shielding layers proximate human finger and pressing under different stretching conditions. View (D) of FIG. 26 is a graphical comparison of noise levels for a sensor with and without the electromagnetic shielding layers at a 1 mm scale.

It was observed that the use of shielding layers enclosing the investigated strain sensor systems can reduce the level of interference. In some aspects, bonding two layers of relatively low-cost, conductive fabrics with laser-cut patterns on the top and bottom surfaces of the example strain sensor systems completes the shielding process. In some aspects, using the depicted cuts can also increase the stretchability of the shielding layers. In some aspects, the addition of the shielding layers can significantly reduce the magnitude of the interference to 1-2% relative capacitance change, which is relatively smaller than strain-induced capacitance changes for relatively large strain sensing. In some aspects, the shielding layers can also improve the signal quality by reducing the noise level from approximately 0.182% to 0.05%, as in FIG. 26D. In some aspects, further noise reduction can be achieved using stretchable conductors such as conductive nanocomposites or liquid metal-filled silicone as shielding materials to provide better coverage of the sensor while maintaining large stretchability.

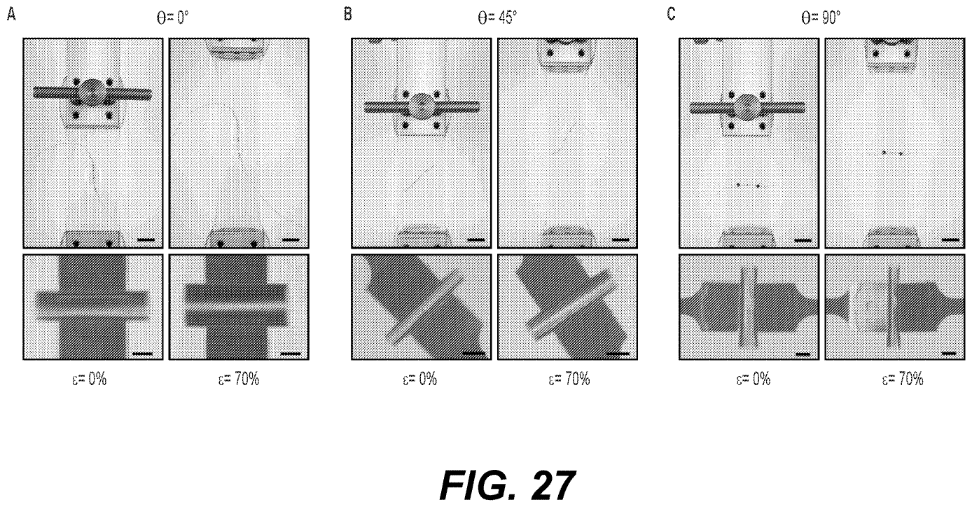

In some aspects, example strain sensor systems of this disclosure can measure relatively large deformations and have been used in soft robots to sense their shapes and deformations. In some aspects, example strain sensor systems of this disclosure are configured for stretching/compression, bending, twisting and/or shear. In some aspects, due to asymmetric structure of electrodes of the strain sensor system, the system can exhibit direction-dependent capacitance changes under stretching applied at different angles with respect to the sensor strip's longitudinal direction. In some aspects, when a sensor strip is attached to a slab of silicone acting as the target surface with the sensor strip aligns with the stretching direction (θ=0°), the corresponding electrodes can unfold, as shown in Views (A) to (C) of FIG. 27, which can increase the bonding site distance and decrease the capacitance. FIG. 27 shows images of a directional strain sensing test of an example strain sensor system of this disclosure. In FIG. 27, the strain sensor system is attached to a silicone slab at view (A) 0°, view (B) 45°, and view (C) 90° angles with respect to the longitudinal direction of the silicone slab. For each direction, the slab is stretched from 0% (left) to 70% strain (right) and the scale is 2 cm for the top row and 250 μm for the bottom row. It was observed that when the sensor strip was perpendicular to the stretching direction (θ=90°), stretching of the target silicone caused compression of the sensor strip due to the Poisson's effect of the stretchable substrate. This compression decreased the bonding site distance, thereby increasing the capacitance.

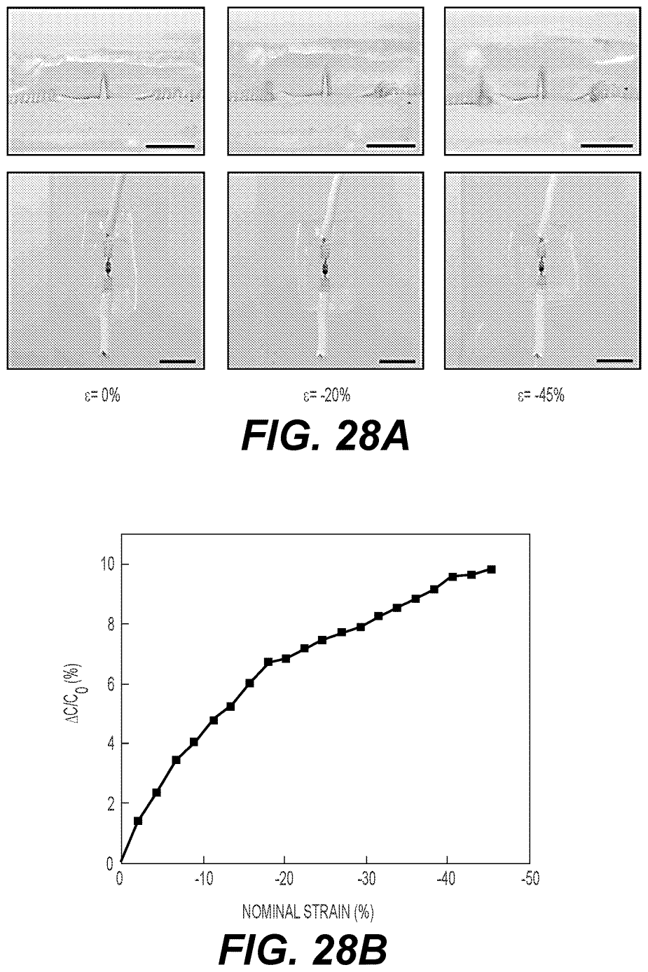

The strain sensor system tested in FIG. 27 can measure also compressive strain from 0 to −45%, despite out-of-plane deformations of certain regions in the traces (e.g., traces 33a, 33b), as shown in FIGS. 28A and 28B which demonstrate changes in the electrodes, traces, and capacitance of the example strain sensor system under compressive strain. FIG. 28A shows a side view (top row) and top-down view (bottom row) of the tested strain sensor system under compressive strain of approximately 0%, −20%, and −45%. FIG. 28B is a graph that compares relative capacitance change of the example strain sensor system under different compressive strain at a scale of 1 mm for the top row and 5 mm for the bottom row in FIG. 28A.

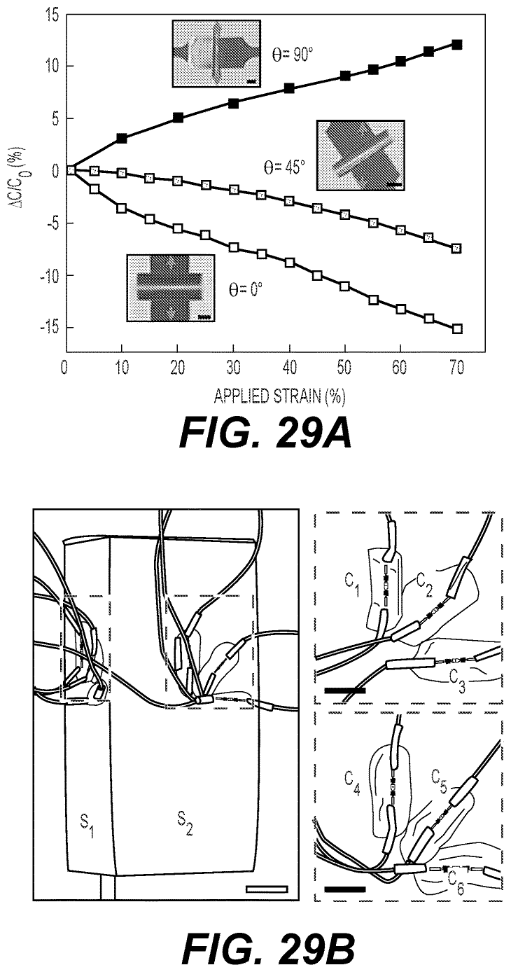

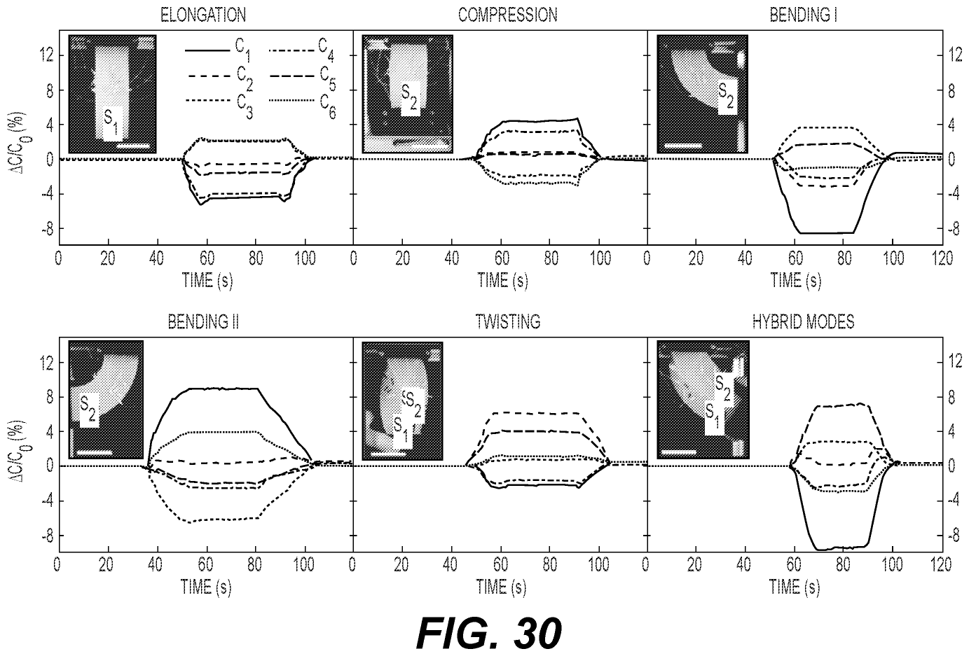

In some aspects, when the stretching direction is at an intermediate angle such as θ=45° with respect to the sensor strip, stretching of the target silicone leads to slight shear movement between bonding sites, which can cause twisting of the 3D electrodes. FIG. 29A is a graph that compares relative capacitance change of an example strain sensor system attached to a silicone slab (e.g., a soft continuum arm) at different angles (0°, 45°, and) 90° with respect to an uniaxial stretching of 70% strain and with inset images that show top-down images of the related electrodes at 70% strain. FIG. 29B illustrates two example configurations of groups of sensors in rosette patterns attached to the two surfaces of a soft continuum arm. FIG. 30 includes graphs of distributed sensor responses during bending, twisting, stretching, compressing, and hybrid deformation modes of the soft continuum arm of FIG. 29B. The S₁ and S₂ faces in the inset images of each graph correspond to those shown in FIG. 29B at a scale of 250 μm 5 cm in C.

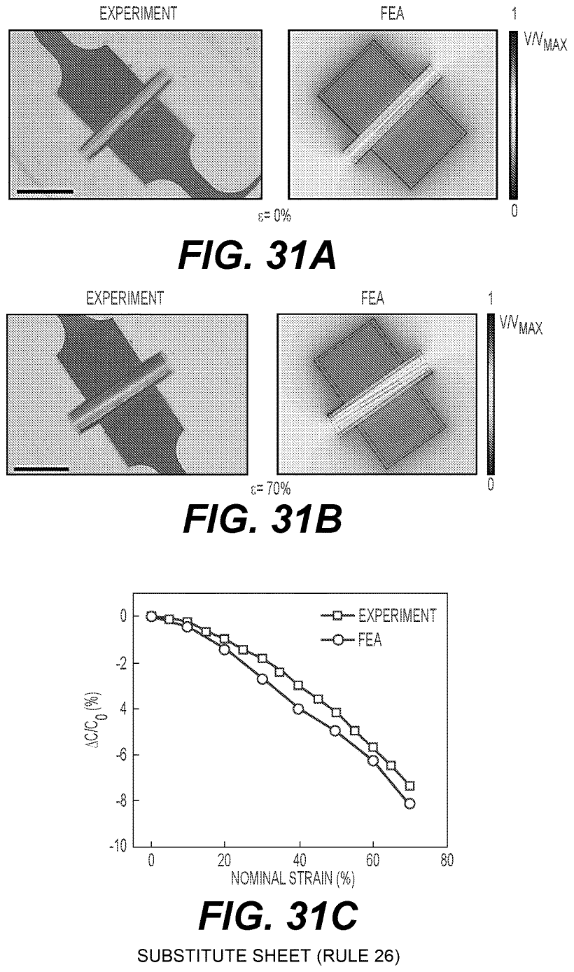

It was observed that the resulting capacitance decrease (see FIG. 29A) can be less than the sensor response at θ=0° and can also be approximated by FEA simulation, as in FIGS. 31A to 31C, which illustrate FEA of sensor stretching at θ=45° direction when attached to a silicone slab at 45° angle with respect to the longitudinal direction of the silicone slab. FIG. 31A illustrates experimental images and simulated electric potential field for the investigated example strain sensor system at 0% strain. FIG. 31B illustrates experimental images and simulated electric potential field for the investigated example strain sensor system being stretched to 70% nominal strain. FIG. 31C is a graph comparing capacitance change from experiment and simulation at a scale 500 μm.

In some aspects, directional sensor responses, combined with a rosette configuration, can support measurements of localized strain in different directions. In the example of FIG. 29B, two three-element) (0°/45°/90° rectangular rosettes are shown attached to two adjacent surfaces (S₁ and S₂) of a soft continuum arm made of silicone using a stick-on method. It was observed that deformations of the soft continuum arm in different modes generated different local strain at the sensor locations, inducing deformation-dependent sensor responses (FIG. 30). Elongation of the arm along the longitudinal direction of the arm was observed to lead to relatively large capacitance decrease in C₁ and C₄, small capacitance decreases in C₂ and C₅, and large capacitance increases in C₃ and C₆, consistent with the results in FIG. 29A. Compression along the arm longitudinal direction generates opposite capacitance changes. The capacitance changes of the distributed sensors allow for the calculation of the local strain using the relationship between capacitance and bonding site distance shown in FIG. 13A.

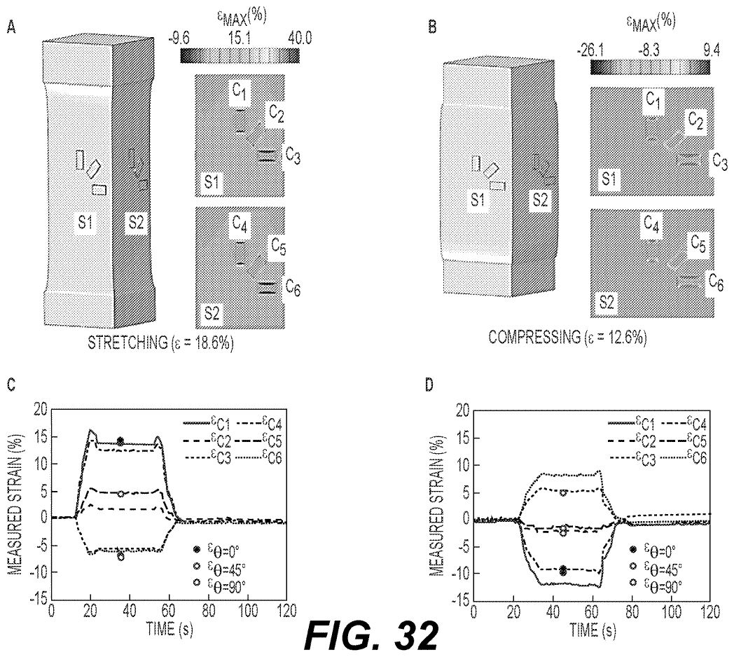

The calculated local strain values from the sensor responses were also compared with those from FEA that captures the geometry and mechanics of the silicone arm and the sensors, as well as the locations and orientation of the sensors, as in views (A) to (D) of FIG. 32 which compare local strain in an example deformed soft continuum arm from FEA and experimental measurements using example strain sensor systems attached to the deformed soft continuum arm. FIG. 32 illustrate FEA simulation results at maximum principal strain distributions of the soft continuum arm under at view (A) 18.6% uniaxial stretching and view (B) 12.6% uniaxial compressing. The measured local directional strain ε from the distributed sensors based on capacitance responses (data lines: ε_{c1} to ε_{c6}) were compared with the simulated local strain from FEA (solid dots: ε_{θ=0°}, ε_{θ=45°}, ε_{θ=90°}) when the arm was under view (C) stretching and view (D) compression. It was observed that the calculated local strain values from the sensors agree reasonably well with those from the FEA. The two rosettes on S₁ and S₂ exhibited different responses in the three groups, C₁ and C₄, C₂ and C₅, and C₃ and C₆, due in part to the manual loading processes that create nonuniform strain distributions for elongation and compression. Differences in the sensor attachment and sensor location estimations from imaging also contributed in part to the observed differences of sensor responses.

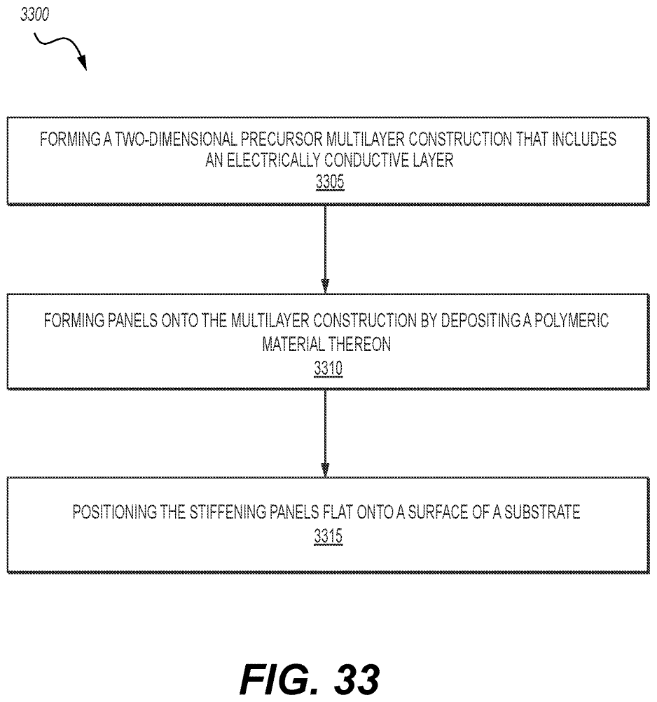

In some aspects, strain sensor systems of this disclosure can be fabricated according to process 3300 described in the flowchart of FIG. 33. Step 3305 of process 3300 can include forming a two-dimensional precursor multilayer construction that includes an electrically conductive layer (e.g., by patterning and etching). Step 3310 of process 3300 can include forming stiffening panels onto the multilayer construction by depositing a polymeric material thereon. In some aspects of step 3310, the step of forming can include curing the polymeric material. In some aspects of step 3310, a series of stiffening panels are formed such that exposed regions of the multilayer construction exist between adjacent stiffening panels. In some aspects of step 3310, first and second stiffening panels form a first foldable electrode and third and fourth stiffening panels form a foldable second electrode. Step 3315 of process 3300 can include positioning the stiffening panels flat onto a surface of a substrate. In some aspects of step 3315, during the step of positioning, the panels can be bonded thereon and the bonding can cause the second and third stiffening panels to extend outwardly away from the elastomeric substrate and form a shape (e.g., a triangle) where the first and second foldable electrodes meet at an apex of the shape.

In some aspects, the substrate of process 3300 can be a uniaxially prestretched substrate (e.g., Ecoflex 00-31). In some aspects, after step 3315 of process 3300, the prestretched substrate can be released to return to its original undeformed state, leading to buckling of the precursor multilayer construction to form its 3D geometry. In an example, the two-dimensional precursor of the process 3300 of FIG. 33 can include a laminate structure of a first polymer layer (e.g., parylene C layer with approximately 5 μm in thickness) at the bottom, a lithographically patterned metal layer (e.g., a transitional metal such as chromium/gold, e.g., 25 nm/200 nm in thickness), and second polymer layer (e.g., parylene C layer (e.g., 5 μm in thickness) above it. Such parylene/metal/parylene pattern created by patterning and etching of the parylene layers defines the multi-panel electrodes and a pair of narrow (e.g., ~100 μm in width) serpentine traces. These traces serve as highly stretchable electrical interconnects between the electrodes and external electronics. A thick (e.g., 35~40 μm in thickness), photodefinable epoxy (e.g., SU-8 25) coated on the top parylene C layer provides stiffening at four patterned, rectangular areas.

In some aspects of process 3300, the cover layer of SU-8 can also significantly increase the bending stiffness by a factor of approximately 130 to 175 as compared that of uncovered regions, thereby forming panel-crease structures. The crease structures (e.g., structures 27a, 27b, 29) in that connects the two electrodes can further reduce the bending stiffness of the crease. In some aspects of process 3300, deposition of a bilayer of Ti/SiO₂ (e.g., 15 nm/50 nm in thickness) on the backside of the two-dimensional precursor through a shadow mask can form sites for covalent bonding to the uniaxially prestretched substrate (e.g., Ecoflex 00-31).

In some aspects of process 3300, releasing the prestrain can impart compressive forces that induce buckling of the unbonded regions of the 2D precursor and subsequent folding deformations in the creases. As a result of the mechanically guided assembly process, the two panels form a triangular shape with the gap between the two bonding sites S0 determined by the electrode length L and the prestrain εₚᵣₑ: S₀=2L/(1+εₚᵣₑ). After the formation of the foldable electrodes, as in process 3300, bonding a top cover to the substate can encapsulate the electrodes. In an example, the cover layer may be formed by replica molding and includes a dome-shaped cavity and two channels (e.g., 2.5 mm in width and e.g., 0.3 mm in thickness) to allow deformations of the electrodes and the traces (e.g., serpentine interconnects), respectively. Filling of the cavity and channels with non-volatile liquid dielectric (e.g., glycerol) can also increase the permittivity of the dielectric medium (e.g., ε=40~50 at 25° C.°) between the electrodes while maintaining the sensor flexibility. This increases the baseline capacitance of the sensor system formed in process 3300, leading to increased signal-to-noise ratio. Electrical connection to the traces and sealing of the fluid channel can complete the device fabrication.

In an example, a fabricated strain sensor system according to process 3300 can have an electrode length of approx. 500 μm, width or approx. 1000 μm, and a 3D structure height of ~560 μm. The active sensing area—the 3D electrode area, is approximately 5 mm². The serpentine interconnects have a width of approx. 110 μm and an adjustable length. The overall dimension of the sensor is tailorable depending on specific applications. For the convenience of mechanical testing, typical sensor adopts a strip shape with approx. 10 mm in width and 10-50 mm in length.

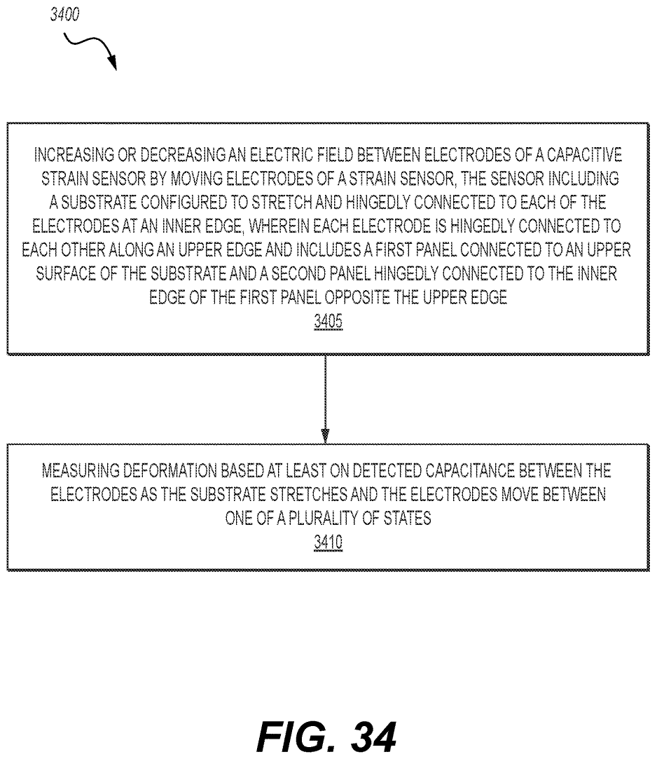

In some examples, strain sensor systems of this disclosure can be used according to method 3400 described in the flowchart of FIG. 34. Step 3405 of method 3400 can include increasing or decreasing an electric field between electrodes of a capacitive strain sensor by moving electrodes of a strain sensor, the sensor including a substrate configured to stretch and hingedly connected to each of the electrodes at an inner edge, wherein each electrode is hingedly connected to each other along an upper edge and includes a first panel connected to an upper surface of the substrate and a second panel hingedly connected to the inner edge of the first panel opposite the upper edge. Step 3410 of method 3400 can include measuring deformation based at least on detected capacitance between the electrodes as the substrate stretches and the electrodes move between one of a plurality of states.

Although systems and methods have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-33 may be modified, and that the foregoing discussion of certain of these embodiments does not necessarily represent a complete description of all possible embodiments. For example, one or more of the procedures, processes, or activities of systems and methods of this disclosure may include different procedures, processes, and/or activities and be performed by some different operation in some different order.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

The specific configurations, choice of materials, concentrations thereof, steps in preparing, and the size and shape of various elements can be varied according to particular design specifications or constraints requiring a system or method constructed according to the principles of the disclosed technology. Such changes are intended to be embraced within the scope of the disclosed technology. The presently disclosed embodiments, therefore, are considered in all respects to be illustrative and not restrictive. It will therefore be apparent from the foregoing that while particular forms of the disclosure have been illustrated and described, various modifications can be made without departing from the spirit and scope of the disclosure and all changes that come within the meaning and range of equivalents thereof are intended to be embraced therein.

What is claimed is:

1. A strain sensor, comprising:
a substrate; and
a pair of electrodes hingedly connected to the substrate at an inner edge and to each other along an upper edge, each electrode comprising:
a first panel connected to an upper surface of the substrate; and
a second panel hingedly connected to the inner edge of the first panel opposite the upper edge;
wherein stretching the substrate causes the pair of electrodes to hingedly move between a first state and a second state.

2. The strain sensor of claim 1, wherein in the first state, the substrate being stretchable comprises a first length defined by the inner edge of each electrode positioned near or adjacent the other so that the upper edge is positioned away from and/or above the substrate.

3. The strain sensor of claim 2, wherein in the first state, the second panels of each electrode collectively form a triangular-shaped structure having an apex at the upper edge.

4. The strain sensor of claim 2, wherein in the second state, the substrate comprises a second length greater than the first length, the second length defined by the inner edge of each electrode positioned away from the other so that the upper edge is positioned in contact and/or adjacent the substrate and the panels of the electrodes are oriented parallel with each other.

5. The strain sensor of claim 1, wherein the substrate is elastomeric.

6. The strain sensor of claim 1, wherein each of the first and second panels comprise one or more conductive layers.

7. The strain sensor of claim 1, wherein the second panel is hingedly connected to the inner edge of the first panel opposite the upper edge with a crease-like structure comprising a polymer material deposited at or along the inner edge.

8. The strain sensor of claim 7, wherein one or more regions of the polymer material remain exposed between adjacent locations comprising the polymer material.

9. The strain sensor of claim 7, wherein the first and second panels of each electrode comprises a multi-layer construction comprising a metal layer sandwiched between a first polymer layer and a second polymer layer.

10. The strain sensor of claim 9, the multi-layer construction further comprising a cover layer disposed over the first polymer layer or the second polymer layer.

11. The strain sensor of claim 9, wherein the first and/or second polymer layers comprise parylene.

12. The strain sensor of claim 9, wherein the metal layer comprises a transition metal.

13. The strain sensor of claim 1, wherein each electrode comprises an electrically conductive trace extending configured to electrically connect with an external electrical device.

14. The strain sensor of claim 13, wherein the electrically conductive traces comprises a serpentine shape configured to stretch during stretching of the substrate.

15. The strain sensor of claim 1, further comprising one or more electromagnetic shielding layers positioned on an outer surface of the substrate and/or each of the electrodes.

16. A capacitive strain sensor, comprising:
a first electrode connected to a second electrode, the first and second electrodes comprising:
a multilayer structure comprising an electrically conductive layer having inner and outer electrically insulating layers; and
an outer polymeric material disposed over the multilayer structure and forming a plurality of panels on the multilayer structure with exposed regions of the multilayer structure interposed therebetween, the panels being arranged in series so that the first electrode is rotatably connected to the second electrode;
a stretchable substrate attached to the first and second electrodes, at least one panel of each electrode being connected to the substrate,
wherein stretching the substrate causes the first and second electrodes to rotatably move between a first state and a second state, the second state being defined by at least one panel of each electrode being positioned upwardly away from the substrate and having an uppermost apex of the capacitive strain sensor.

17. The sensor of claim 16, wherein the panels of the first and second electrodes comprise stiffness to facilitate creasing of the exposed regions between the first and second states.

18. The sensor of claim 16, wherein the multilayer structure comprises a first polymer layer, a metal layer, and a second polymer layer.

19. The sensor of claim 16, further comprising an electrically nonconductive material disposed over and encapsulating the first and second electrodes.

20. A method, comprising:
increasing or decreasing an electric field between electrodes of a capacitive strain sensor by moving electrodes of a strain sensor, the sensor including a substrate configured to stretch and hingedly connected to each of the electrodes at an inner edge, wherein each electrode is hingedly connected to each other along an upper edge and includes a first panel connected to an upper surface of the substrate and a second panel hingedly connected to the inner edge of the first panel opposite the upper edge; and
measuring deformation based at least on detected capacitance between the electrodes as the substrate stretches and the electrodes move between one of a plurality of states.
